(19) United States
(12) Patent Application Publication
(10) Pub. No.: US 2024/0307740 A1
(43) Pub. Date: Sep. 19, 2024

(54) PRINTED GOLF BALLS

(71) Applicant: Taylor Made Golf Company, Inc., Carlsbad, CA (US)

(72) Inventor: Tim DURHAM, Cleveland, SC (US)

(21) Appl. No.: 18/606,238

(22) Filed: Mar. 15, 2024

Related U.S. Application Data
(60) Provisional application No. 63/491,014, filed on Mar. 17, 2023.
(60) Provisional application No. 63/503,257, filed on May 19, 2023.

(51) Int. Cl. A63B 45/02; A63B 37/00; B41F 17/00; B41F 17/30

(52) U.S. Cl. CPC A63B 45/02; A63B 37/002; B41F 17/001; B41F 17/006; B41F 17/30

(57) ABSTRACT

Pad printed golf balls comprising a plurality of partially overlapping pad printed areas. The pad printed areas can comprise a surface area occupying at least 20% of a total surface area of the golf ball and a pad printed image occupying a portion of the surface area. Two or more of the pad printed areas can partially overlap in an overlap area where a portion of both a first pad printed image and second pad printed image are located. In some embodiments, an overlap area can have an overlap surface area greater than or equal to 5% of the surface area for a pad printed area.

### CROSS-REFERENCE TO RELATED APPLICATIONS

This application claims priority to the following U.S. Provisional Applications: U.S. Provisional Application No. 63/491,014, filed Mar. 17, 2023, and U.S. Provisional Application No. 63/503,257, filed May 19, 2023. Each of these applications is incorporated herein in its entirety by reference thereto.

### FIELD

The present disclosure relates to pad printing graphics on a ball. In particular, the present disclosure relates to pad printing a graphic on a golf ball by pad printing two or more overlapping image areas that define at least a portion of the graphic.

### BACKGROUND

Images printed on a ball, for example a golf ball, can serve various functions, including identifying a particular ball, providing an alignment feature, and/or customizing a ball to a player's liking. The clarity and aesthetics of the printed images on the golf ball can be important for a player.

### BRIEF DESCRIPTION OF THE DRAWINGS/FIGURES

The accompanying drawings, which are incorporated herein and form a part of the specification, illustrate the present disclosure and, together with the description, further serve to explain the principals thereof and to enable a person skilled in the pertinent art to make and use the same. Aspects of the present disclosure are best understood from the following detailed description when read with the accompanying figures. It is noted that, in accordance with the standard practice in the industry, features are not drawn to scale. In fact, the dimensions of the features may be arbitrarily increased or reduced for clarity of discussion.

FIGS. 1A and 1B illustrate a golf ball according to some embodiments.

FIG. 2 illustrates a pad printed area according to some embodiments.

FIG. 3A illustrates an overlap area for two pad printed areas according to some embodiments. FIG. 3B illustrates an overlap area for two pad printed areas with an image overlap area according to some embodiments.

FIG. 4 illustrates an overlap area for three pad printed areas according to some embodiments.

FIG. 5 illustrates four overlapping pad printed areas according to some embodiments.

FIG. 6 illustrates a pad printing system according to some embodiments.

FIG. 7 illustrates a golf ball comprising three pad printed areas.

FIG. 8A illustrates a golf ball having a printed arc diameter.

FIG. 8B illustrates a golf ball having a printed arc length and width.

### BRIEF SUMMARY

The present disclosure describes pad printing techniques for pad printing a graphic on a ball, and balls comprising the graphic printed using the pad printing techniques described.

A first embodiment (1) of the present disclosure is directed to a pad printed golf ball, comprising a plurality of pad printed areas, comprising a first pad printed area comprising a first surface area occupying at least 20% of a total surface area of the golf ball, and a first pad printed image occupying a portion of the first surface area; and a second pad printed area comprising a second surface area occupying at least 20% of the total surface area of the golf ball, and a second pad printed image occupying a portion of the second surface area; wherein the first surface area and the second surface area partially overlap in an overlap area, wherein a portion of the first pad printed image is located in the overlap area and a portion of the second pad printed image is located in the overlap area, and wherein the overlap area has an overlap surface area greater than or equal to 5% of the first surface area.

In a second embodiment (2), the overlap surface area according to the first embodiment (1) is greater than or equal to 10% of the first surface area and less than or equal to 50% of the first surface area.

In a third embodiment (3), the overlap surface area according to the first embodiment (1) is greater than or equal to 10% of the first surface area and less than or equal to 40% of the first surface area.

In a fourth embodiment (4), the pad printed golf ball according to any one of embodiments (1)-(3) further comprises a third pad printed area comprising a third surface area occupying at least 20% of the total surface area of the golf ball, and a third pad printed image occupying a portion of the third surface area.

In a fifth embodiment (5), the first surface area, the second surface area, and the third surface area according to the fourth embodiment (4) partially overlap in a second overlap area, wherein a portion of the first pad printed image is located in the second overlap area, a portion of the second pad printed image is located in the second overlap area, and a portion of the third pad printed image is located in the second overlap area, and wherein the second overlap area has an overlap surface area greater than or equal to 5% of the first surface area.

In a sixth embodiment (6), in the overlap area according to any one of embodiments (1)-(5), no ink defining the first pad printed image overlaps ink defining the second pad printed image.

In a seventh embodiment (7), in the overlap area according to any one of embodiments (1)-(5), the first pad printed image comprises a first part where ink defining the first pad printed image does not overlap ink defining the second pad printed image, and a second part wherein ink defining the first pad printed image overlaps ink defining the second pad printed image in an image overlap area, wherein the first part of the first pad printed image comprises a first ink density, and wherein the second part of the first pad printed image comprises a second ink density less than the first ink density.

In an eighth embodiment (8), the second ink density according to the seventh embodiment (7) is 40% to 60% of the first ink density.

In a ninth embodiment (9), the ink defining the second pad printed image in the image overlap area according to the seventh embodiment (7) comprises a third ink density less than the first ink density.

In a tenth embodiment (10), the third ink density according to the ninth embodiment (9) is 40% to 60% of the first ink density.

In an eleventh embodiment (11), the pad printed golf ball according to any one of embodiments (1)-(3) further comprises a third pad printed area comprising a third surface area occupying at least 20% of a total surface area of the golf ball, and a third pad printed image occupying a portion of the third surface area; and a fourth pad printed area comprising a fourth surface area occupying at least 20% of the total surface area of the golf ball, and a fourth pad printed image occupying a portion of the fourth surface area.

In a twelfth embodiment (12), the second surface area and the third surface area according to the eleventh embodiment (11) partially overlap in a second overlap area, wherein a portion of the second pad printed image is located in the second overlap area and a portion of the third pad printed image is located in the second overlap area, and wherein the second overlap area has an overlap surface area greater than or equal to 5% of the second surface area.

In a thirteenth embodiment (13), the third surface area and the fourth surface area according to the twelfth embodiment (12) partially overlap in a third overlap area, wherein a portion of the third pad printed image is located in the third overlap area and a portion of the fourth pad printed image is located in the third overlap area, and wherein the third overlap area has an overlap surface area greater than or equal to 5% of the third surface area.

In a fourteenth embodiment (14), the fourth surface area and the first surface area according to the thirteenth embodiment (13) partially overlap in a fourth overlap area, wherein a portion of the fourth pad printed image is located in the fourth overlap area and a portion of the first pad printed image is located in the fourth overlap area, and wherein the fourth overlap area has an overlap surface area greater than or equal to 5% of the fourth surface area.

In a fifteenth embodiment (15), the pad printed golf ball according to the fourteenth embodiment (14) further comprises a fifth pad printed area comprising a fifth surface area occupying at least 20% of a total surface area of the golf ball, and a fifth pad printed image occupying a portion of the fifth surface area, wherein the fifth pad printed area partially overlaps each of the first pad printed area, the second pad printed area, the third pad printed area, and the fourth pad printed area.

In a sixteenth embodiment (16), the pad printed golf ball according to the fifteenth embodiment (15) further comprises a sixth pad printed area comprising a sixth surface area occupying at least 20% of a total surface area of the golf ball, and a sixth pad printed image occupying a portion of the sixth surface area, wherein the sixth pad printed area partially overlaps each of the first pad printed area, the second pad printed area, the third pad printed area, and the fourth pad printed area.

In a seventeenth embodiment (17), at least 10% of the total surface area of the golf ball according to the sixteenth embodiment (16) is occupied by three of the pad printed areas.

In an eighteenth embodiment (18), at least 70% of the total surface area of the golf ball according to the sixteenth embodiment (16) is occupied by at least two of the pad printed areas.

In a nineteenth embodiment (19), the first pad printed image according to any one of embodiments (1)-(10) occupies at least 20% of the first surface area, and the second pad printed image according to any one of embodiments (1)-(10) occupies at least 20% of the second surface area.

In a twentieth embodiment (20), at least 5% of the first pad printed image according to any one of embodiments (1)-(10) is located in the first overlap area and at least 5% of the second pad printed image according to any one of embodiments (1)-(10) is located in the first overlap area.

A twenty-second embodiment (21) of the present disclosure is directed to a method of pad printing a graphic on a golf ball, the method comprising pad printing a first image defining a portion of the graphic with a first pad configured to pad print on a first surface area occupying at least 20% of a total surface area of the golf ball, wherein the first image occupies a portion of the first surface area; rotating the golf ball about a central longitudinal axis of the ball; and pad printing a second image defining a portion of the graphic with a second pad configured to pad print on a second surface area occupying at least 20% of the total surface area of the golf ball, wherein the second image occupies a portion of the second surface area, wherein the first surface area and the second surface area partially overlap in an overlap area, wherein a portion of the first image is located in the overlap area and a portion of the second image is located in the overlap area, and wherein the overlap area has an overlap surface area greater than or equal to 5% of the first surface area.

A twenty-second embodiment (22) of the present disclosure is directed to a pad printed golf ball, comprising a plurality of pad printed areas, comprising a first pad printed area comprising a first surface area occupying at least 15% of a total surface area of the golf ball, and a first pad printed image occupying a portion of the first surface area; a second pad printed area comprising a second surface area occupying at least 15% of the total surface area of the golf ball, and a second pad printed image occupying a portion of the second surface area; a third pad printed area comprising a third surface area occupying at least 15% of the total surface area of the golf ball, and a third pad printed image occupying a portion of the third surface area; and a dead zone located between the pad first printed area, the second pad printed area, and the third pad printed area, wherein: the first surface area and the second surface area partially overlap in a first overlap area, the first surface area and the third surface area partially overlap in a second overlap area, the second surface area and the third surface area partially overlap in a third overlap area, and none of the first surface area, the second surface area, or the third surface area overlap in the dead zone.

In a twenty-third embodiment (23), in the dead zone according to the twenty-second embodiment (22), no ink is applied to the golf ball through pad printing.

In a twenty-fourth embodiment (24), the first overlap area, the second overlap area, and the third overlap area according to the twenty-second embodiment (22) or the twenty-third embodiment (23) each occupy between 1% and 5% of the total surface area of the golf ball.

In a twenty-fifth embodiment (25), the dead zone according to any one of embodiments (22)-(24) occupies less than or equal to 0.5% of the total surface area of the golf ball.

In a twenty-sixth embodiment (26), a portion of the first pad printed image according to any one of embodiments (22)-(25) is located in the first overlap area and a portion of the second pad printed image according to any one of embodiments (22)-(25) is located in the first overlap area.

In a twenty-seventh embodiment (27), the first pad printed image according to any one of embodiments (22)-(26) comprises a first color and the second pad printed image according to any one of embodiments (22)-(26) comprises a second color different from the first color.

In a twenty-eighth embodiment (28), the first color and the second color according to the twenty-seventh embodiment (27) are located in the first overlap area.

In a twenty-ninth embodiment (29), in the first overlap area according to any one of embodiments (22)-(28), no ink defining the first pad printed image overlaps ink defining the second pad printed image.

In a thirtieth embodiment (30), in the first overlap area according to any one of embodiments (22)-(28), the first pad printed image comprises a first part where ink defining the first pad printed image does not overlap ink defining the second pad printed image, and a second part wherein ink defining the first pad printed image overlaps ink defining the second pad printed image in an image overlap area, wherein the first part of the first pad printed image comprises a first ink density, and wherein the second part of the first pad printed image comprises a second ink density less than the first ink density.

In a thirty-first embodiment (31), the first pad printed area according to any one of embodiments (22)-(30) comprises a printed planar diameter between 28 mm and 37 mm.

In a thirty-second embodiment (32), the first pad printed area according to any one of embodiments (22)-(31) comprises a printed arc diameter between 31 mm and 45 mm.

In a thirty-third embodiment (33), any one of the first pad printed area, the second pad printed area, or the third pad printing area according to any one of embodiments (22)-(30) comprises a non-circular perimeter shape comprising a maximum printed arc length between 34 mm and 47 mm and a maximum printed arc width between 28 mm and 40 mm.

In a thirty-fourth embodiment (34), the first pad printed image according to any one of embodiments (22)-(33) occupies at least 20% of the first surface area, the second pad printed image according to any one of embodiments (22)-(33) occupies at least 20% of the second surface area, and the third pad printed image according to any one of embodiments (22)-(33) occupies at least 20% of the third surface area.

In a thirty-fifth embodiment (35), at least 5% of the first pad printed image according to any one of embodiments (22)-(34) is located in the first overlap area and at least 5% of the second pad printed image according to any one of embodiments (22) -(34) is located in the first overlap area.

A thirty-sixth embodiment (36) of the present disclosure is directed to a pad printed golf ball, comprising a plurality of pad printed areas, comprising a first pad printed area comprising a first surface area occupying at least 15% of a total surface area of the golf ball, and a first pad printed image occupying a portion of the first surface area; a second pad printed area comprising a second surface area occupying at least 15% of the total surface area of the golf ball, and a second pad printed image occupying a portion of the second surface area; a third pad printed area comprising a third surface area occupying at least 15% of the total surface area of the golf ball, and a third pad printed image occupying a portion of the third surface area; a fourth pad printed area comprising a fourth surface area occupying at least 15% of the total surface area of the golf ball, and a fourth pad printed image occupying a portion of the fourth surface area; a fifth pad printed area comprising a fifth surface area occupying at least 15% of the total surface area of the golf ball, and a fifth pad printed image occupying a portion of the fifth surface area; a sixth pad printed area comprising a sixth surface area occupying at least 15% of the total surface area of the golf ball, and a sixth pad printed image occupying a portion of the sixth surface area; and an overlap area where the first pad printed area and the second pad printed area overlap such that at least a portion of the first pad printed image and at least a portion of the second pad printed image are located in the overlap area, wherein each of the six pad printed images comprises a color, and wherein the color for at least one of the six pad printed images is different from the color for a different one of the six pad printed images.

In a thirty-seventh embodiment (37), the first pad printed image according to the thirty-sixth embodiment (36) comprises a first color located in the overlap area and the second pad printed image according to the thirty-sixth embodiment (36) comprises a second color different from the first color, and both the first color and the second color are located in the overlap area.

In a thirty-eighth embodiment (38), the overlap area of the thirty-sixth embodiment (36) or thirty-seventh embodiment (37) is a first overlap area, the pad printed golf ball of the thirty-sixth embodiment (36) or thirty-seventh embodiment (37) comprises eleven additional overlap areas, and in each of the eleven additional overlap areas, two of the respective six pad printed areas overlap such that at least a portion of the pad printed images for the two pad printed areas are located in the respective overlap area.

A thirty-ninth embodiment (39) of the present disclosure is directed to a method of pad printing a graphic on a golf ball, the method comprising lifting a first two-dimensionally distorted image from a first printing plate with a first pad; pad printing a first image defining a portion of the graphic with the first pad configured to pad print on a first surface area occupying at least 15% of a total surface area of the golf ball, wherein the first image occupies a portion of the first surface area and comprises the first two-dimensionally distorted image printed in a non-distorted three-dimensional form; rotating the golf ball about a central longitudinal axis of the ball; lifting a second two-dimensionally distorted image from a second printing plate with a second pad; and pad printing a second image defining a portion of the graphic with a second pad configured to pad print on a second surface area occupying at least 15% of the total surface area of the golf ball, wherein the second image occupies a portion of the second surface area and comprises the second two-dimensionally distorted image printed in a non-distorted three-dimensional form, wherein the first surface area and the second surface area partially overlap in an overlap area, and wherein a portion of the first image in the non-distorted three-dimensional form is located in the overlap area and a portion of the second image in the non-distorted three-dimensional form is located in the overlap area.

In a fortieth embodiment (40), the first print pad according to the thirty-ninth embodiment (39), the second print pad according to the thirty-ninth embodiment (39), or both, comprises a Shore A hardness between 30 to 60.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

Embodiments described herein comprise a golf ball comprising a graphic defined by two or more overlapping pad printed areas. Each of the overlapping pad printed areas comprises a pad printed image occupying a portion of the pad printed area. As described herein, the pad printed images for adjacent overlapping pad printed areas are at least partially located in an overlap area of the adjacent overlapping pad printed areas. By designing the pad printed areas, pad printed images, and overlap areas as described herein, unique graphics defined by a plurality of pad printed images can be pad printed on the golf ball.

In some embodiments, the unique graphics can comprise a graphic that spans the entirety of a ball's spherical surface area. The unique graphics can be pad printed without visually noticeable seams in portions of the graphic. Also, the unique graphics can appear as a continuous graphic that spans the entirety of a ball's surface area without noticeable “white space” areas lacking the graphical image or pattern created by the continuous graphic.

In some embodiments, the unique graphics can be defined by six overlapping pad printed areas. In such embodiments, the six overlapping pad printed areas can comprise twelve areas in which two of the pad printed areas overlap and eight areas in which three of the pad printed areas overlap. By designing the six overlapping pad printed areas as described herein, unique graphics that span the entirety of a ball's spherical surface area in a seamless and visually continuous way can be created.

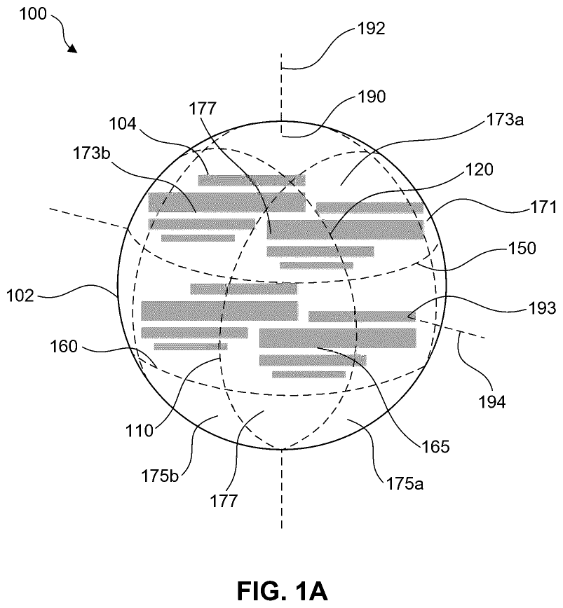

FIG. 1 illustrates a golf ball 100 according to some embodiments. Golf ball 100 comprises a spherical surface 102 having a total surface area. Surface 102 comprises a graphic 104 pad printed on the surface 102. In some embodiments, surface 102 can be an outer-most surface of golf ball 100. In some embodiments, surface 102 can be a surface located below an outer-most surface of golf ball 100. For example, in some embodiments, the golf ball 100 can comprise surface 102 and a protective coating layer disposed on surface 102 and defining the outer-most surface of golf ball 100. In such embodiments, graphic 104 can be located on surface 102 and covered by the protective coating layer.

In some embodiments, the total surface area for golf ball 100 can range from greater than or equal to 5500 mm² to less than or equal to 6000 mm². In some embodiments, the total surface area for golf ball 100 can range from greater than or equal to 5700 mm² to less than or equal to 5800 mm². For example, for a golf ball having a 42.67-mm diameter, or between 42 mm and 43 mm, the total outer surface area can be between 5710 mm² and 5750 mm². In some embodiments, the total outer surface area can be between 5730 mm² to 5750 mm² when the dimples contours are accounted for. As used herein, when a range is described as “between” two values, the range includes the lower end and the upper end of the range. For example, a surface area described as between 5500 mm² and 6000 mm², means the surface area can range from greater than or equal to 5500 mm² to less than or equal to 6000 mm².

Surface 102 of golf ball 100 can be a dimpled surface comprising a dimple pattern designed to impart desired aerodynamic characteristics to golf ball 100. For purposes of assessing a surface area on golf ball 100 for the present application, the relevant surface of the ball is assumed to have dimples. As an illustrative example, if a circular surface area on ball 100 has a surface area of 55 mm² with dimples and a surface area of 50 mm² with the dimples filled in, the surface area of 55 mm² is used as the surface area for that circular surface area.

Graphic 104 on golf ball 100 comprises a plurality of partially overlapping pad printed areas, with each pad printed area comprising a pad printed image occupying a portion of the respective pad printed area. Together, the pad printed images define the graphic 104 on golf ball 100.

As used herein, a “pad printed area” or “print zone” is an area on surface 102 that is contacted by a printing pad during a pad printing step. For example, if a printing pad is configured to be capable of printing on an area of surface 102 having a surface area of 1438.85 mm², then the pad printed area for that pad is 1438.85 mm². Unless specified otherwise, the entirety of a pad printed area or print zone is not occupied by a pad printed image. In other words, unless specified otherwise, there is at least some area within a pad printed area that is free of a pad printed image.

As used herein, a “pad printed image” is an image defined by ink printed within a pad printed area. In some embodiments, a pad printed image can include one ink color. In some embodiments, a pad printed image can include more than one ink color. In such embodiments, the pad printed image can be printed in separate pad printing steps, one for a first color, one for a second color, and so on. In embodiments comprising a pad printed image with more than one ink color, each color can be printed in the same pad printed area.

Exemplary pad printed images comprise, but are not limited to, one or more basic geometrical shapes, one or more a symbols, a regular or irregular pattern of one or more basic geometrical shapes, a regular or irregular pattern of one or more symbols, or a regular or irregular stripe pattern. In some embodiments, pad printed images can comprise a dotted image comprising a plurality of dots. In some embodiments, the dots can be arranged in a regular or irregular pattern, such as a pixelated pattern. In such embodiments, the dots can be in the form of circles, squares, triangles, ovals, irregular shapes, or a combination thereof, to provide some examples. In some embodiments, pad printed images can comprise a striped image comprising a plurality of stripes. In some embodiments, the stripes can be arranged in a regular or irregular pattern. In such embodiments, the stripes can be in the form of rectangles, triangles, ovals, irregular shapes, or a combination thereof, to provide some examples. Pad printed images printed according to embodiments described herein can additionally comprise, but are not limited to logos, trademarks, technology names, alignment features (for example an alignment arrow or band), custom images, ball numbers, and other ball indicia.

Pad printed images as described herein can be pad printed using a pad transfer printing method in which an inked image is lifted from an engraved area of printing plate (sometimes referred to as a “cliche plate”) and transferred to surface 102 of ball 100 by a resilient ink transfer pad, typically made of a soft material like silicone rubber. In some embodiments, the resilient ink transfer pad can have a shore A hardness between 20 and 70, between 30 and 60, or between 45 and 55. The surface characteristics of the ink transfer pad are such that the ink easily releases from the pad and adheres to surface 102. The transfer pad can elastically deform during printing so that when it contacts surface 102 it covers a desired pad printed area.

In some embodiments, an open or closed reservoir ink assembly can be used in a pad transfer printing apparatus. With an open-reservoir ink assembly, typically, ink is held in an open trough or reservoir, and the engraved area of the printing plate is filled by taking the ink from the trough or reservoir by means of a brush, spreader blade, wire applicator or the like, and applying the ink to the engraved area of the printing plate. A doctor blade or other type of wiping or scraping device can then be used to remove excess ink from the plate so that the ink remains only in the grooves or depressions of the engraved area that define the legend to be printed.

With a closed-reservoir ink assembly, the ink reservoir can be inverted and the printing plate positioned beneath the assembly so that the plate holds the ink within the reservoir. As the engraved image of the printing plate moves beneath the reservoir, the ink fills the engraving. The closed-reservoir ink assembly can be provided with a doctoring edge that scrapes excess ink from the plate as the plate moves underneath the ink assembly. In some closed-reservoir ink assemblies, the doctoring edge can be provided on the inverted reservoir.

Golf ball 100 can comprise a top pole 190, a bottom pole 191, and a longitudinal axis 192. The longitudinal axis 192 extends through the top pole 190, the bottom pole 191, and a geometrical center of ball 100. Golf ball 100 can also comprise an equator 193 and a transverse axis 194. The transverse axis 194 extends through the equator 193 and through the geometrical center of ball 100 in a direction perpendicular to longitudinal axis 192. Poles 190, 191 and axes 192 and 194 can be used to define the location of pad printed areas on a golf ball 100 described herein. That said, unless specified otherwise, the location of poles 190, 191 and axes 192 and 194 are not based on any particular standard locations on a golf ball.

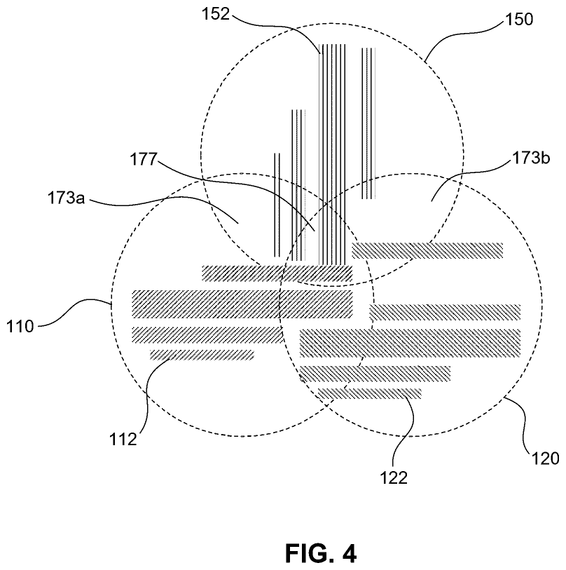

Referring to FIG. 5, in some embodiments, golf ball 100 can comprise a first pad printed area 110 comprising a first pad printed image 112. In some embodiments, golf ball 100 can comprise a second pad printed area 120 comprising a second pad printed image 122. In some embodiments, golf ball 100 can comprise a third pad printed area 130 comprising a third pad printed image 132. In some embodiments, golf ball 100 can comprise a fourth pad printed area 140 comprising a fourth pad printed image 142. In some embodiments, golf ball 100 can comprise a fifth pad printed area 150 comprising a fifth pad printed image 152. In some embodiments, golf ball 100 can comprise a sixth pad printed area 160 comprising a sixth pad printed image 162.

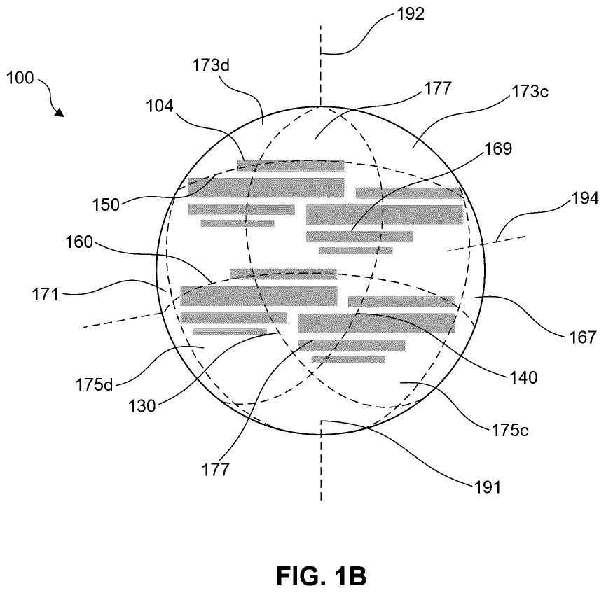

FIG. 2 illustrates a pad printed area comprising a pad printed image according to some embodiments. The pad printed area shown in FIG. 2 can be any one of pad printed area 110, 120, 130, 140, 150, 160 with pad printed image 112, 122, 132, 142, 152, 162.

In some embodiments, golf ball 100 can comprise two or more of: first pad printed area 110, second pad printed area 120, third pad printed area 130, fourth pad printed area 140, fifth pad printed area 150, and sixth pad printed area 160. In some embodiments, golf ball 100 can comprise three or more of: first pad printed area 110, second pad printed area 120, third pad printed area 130, fourth pad printed area 140, fifth pad printed area 150, and sixth pad printed area 160. In some embodiments, golf ball 100 can comprise four or more of: first pad printed area 110, second pad printed area 120, third pad printed area 130, fourth pad printed area 140, fifth pad printed area 150, and sixth pad printed area 160. In some embodiments, golf ball 100 can comprise five of: first pad printed area 110, second pad printed area 120, third pad printed area 130, fourth pad printed area 140, fifth pad printed area 150, and sixth pad printed area 160. In some embodiments, golf ball 100 can comprise all six of: first pad printed area 110, second pad printed area 120, third pad printed area 130, fourth pad printed area 140, fifth pad printed area 150, and sixth pad printed area 160.

While pad printed areas 110, 120, 130, 140, 150, 160 may be illustrated as having a circular perimeter shape herein, the perimeter shape is not limited to a circular shape. The perimeter shape can be any shape such as an ellipse, a truncated circle, a rectangle, a triangle, a polygon, a circle with at least two substantially flat sides, or other complex non-polygonal shapes.

As used herein, unless specified otherwise, references to “first,” “second,” “third,” “fourth,” etc. are not intended to denote order, or that an earlier-numbered feature is required for a later-numbered feature.

In some embodiments, first pad printed area 110, second pad printed area 120, third pad printed area 130, and fourth pad printed area 140 can be located on or even centered or oriented about an equator 193 of golf ball 100. In such embodiments, a geometrical center of first pad printed area 110, second pad printed area 120, third pad printed area 130, and fourth pad printed area 140 can be located on equator 193. In some embodiments, fifth pad printed area 150 can be located on top pole 190 of golf ball 100. In such embodiments, a geometrical center of fifth pad printed area 150 can be located at top pole 190 of golf ball. In some embodiments, sixth pad printed area 160 can be located on bottom pole 191 of golf ball 100. In such embodiments, a geometrical center of sixth pad printed area 160 can be located at bottom pole 191 of golf ball 100.

First pad printed area 110 can comprise a first surface area occupying at least 20% of the total surface area of golf ball 100. In some embodiments, the first surface area can occupy greater than or equal to 20% of the total surface area to less than or equal to 30% of the total surface area. In some embodiments, the first surface area can occupy greater than or equal to 22% of the total surface area to less than or equal to 30% of the total surface area. In some embodiments, the first surface area can occupy greater than or equal to 24% of the total surface area to less than or equal to 30% of the total surface area. In some embodiments, the first surface area can occupy greater than or equal to 20% of the total surface area to less than or equal to 28% of the total surface area. In some embodiments, the first surface area can occupy greater than or equal to 20% of the total surface area to less than or equal to 26% of the total surface area.

In some embodiments, the first surface area for first pad printed area 110 can comprise a surface area ranging from greater than or equal 1000 mm² to less than or equal to 2000 mm², including subranges. For example, in some embodiments, the first surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the first surface area for first pad printed area 110 can comprise a surface area ranging from greater than or equal 1400 mm² to less than or equal to 1500 mm².

First pad printed image 112 occupies a portion of the first surface area for first pad printed area 110. In some embodiments, the first pad printed image 112 can occupy at least 20% of the first surface area. In some embodiments, the first pad printed image 112 can occupy at least 30% of the first surface area. In some embodiments, the first pad printed image 112 can occupy at least 50% of the first surface area. In some embodiments, the first pad printed image 112 can occupy an area greater than or equal to 20% of the first surface area to less than or equal to 90% of the first surface area. In some embodiments, the first pad printed image 112 can occupy an area greater than or equal to 20% of the first surface area to less than or equal to 80% of the first surface area. In some embodiments, the first pad printed image 112 can occupy an area greater than or equal to 20% of the first surface area to less than or equal to 70% of the first surface area. In some embodiments, the first pad printed image 112 can occupy an area greater than or equal to 20% of the first surface area to less than or equal to 60% of the first surface area. In some embodiments, the first pad printed image 112 can occupy an area greater than or equal to 20% of the first surface area to less than or equal to 50% of the first surface area. In some embodiments, the first pad printed image 112 can occupy an area greater than or equal to 30% of the first surface area to less than or equal to 90% of the first surface area. In some embodiments, the first pad printed image 112 can occupy an area greater than or equal to 50% of the first surface area to less than or equal to 90% of the first surface area.

Second pad printed area 120 can comprise a second surface area occupying at least 20% of the total surface area of golf ball 100. In some embodiments, the second surface area can occupy greater than or equal to 20% of the total surface area to less than or equal to 30% of the total surface area. In some embodiments, the second surface area can occupy greater than or equal to 22% of the total surface area to less than or equal to 30% of the total surface area. In some embodiments, the second surface area can occupy greater than or equal to 24% of the total surface area to less than or equal to 30% of the total surface area. In some embodiments, the second surface area can occupy greater than or equal to 20% of the total surface area to less than or equal to 28% of the total surface area. In some embodiments, the second surface area can occupy greater than or equal to 20% of the total surface area to less than or equal to 26% of the total surface area.

In some embodiments, the second surface area for second pad printed area 120 can comprise a surface area ranging from greater than or equal 1000 mm² to less than or equal to 2000 mm², including subranges. For example, in some embodiments, the second surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the second surface area for second pad printed area 120 can comprise a surface area ranging from greater than or equal 1400 mm² to less than or equal to 1500 mm².

Second pad printed image 122 occupies a portion of the second surface area for second pad printed area 120. In some embodiments, the second pad printed image 122 can occupy at least 20% of the second surface area. In some embodiments, the second pad printed image 122 can occupy at least 30% of the second surface area. In some embodiments, the second pad printed image 122 can occupy at least 50% of the second surface area. In some embodiments, the second pad printed image 122 can occupy an area greater than or equal to 20% of the second surface area to less than or equal to 90% of the second surface area. In some embodiments, the second pad printed image 122 can occupy an area greater than or equal to 20% of the second surface area to less than or equal to 80% of the second surface area. In some embodiments, the second pad printed image 122 can occupy an area greater than or equal to 20% of the second surface area to less than or equal to 70% of the second surface area. In some embodiments, the second pad printed image 122 can occupy an area greater than or equal to 20% of the second surface area to less than or equal to 60% of the second surface area. In some embodiments, the second pad printed image 122 can occupy an area greater than or equal to 20% of the second surface area to less than or equal to 50% of the second surface area. In some embodiments, the second pad printed image 122 can occupy an area greater than or equal to 30% of the second surface area to less than or equal to 90% of the second surface area. In some embodiments, the second pad printed image 122 can occupy an area greater than or equal to 50% of the second surface area to less than or equal to 90% of the second surface area.

Third pad printed area 130 can comprise a third surface area occupying at least 20% of the total surface area of golf ball 100. In some embodiments, the third surface area can occupy greater than or equal to 20% of the total surface area to less than or equal to 30% of the total surface area. In some embodiments, the third surface area can occupy greater than or equal to 22% of the total surface area to less than or equal to 30% of the total surface area. In some embodiments, the third surface area can occupy greater than or equal to 24% of the total surface area to less than or equal to 30% of the total surface area. In some embodiments, the third surface area can occupy greater than or equal to 20% of the total surface area to less than or equal to 28% of the total surface area. In some embodiments, the third surface area can occupy greater than or equal to 20% of the total surface area to less than or equal to 26% of the total surface area.

In some embodiments, the third surface area for second pad printed area 130 can comprise a surface area ranging from greater than or equal 1000 mm² to less than or equal to 2000 mm², including subranges. For example, in some embodiments, the third surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the third surface area for third pad printed area 130 can comprise a surface area ranging from greater than or equal 1400 mm² to less than or equal to 1500 mm².

Third pad printed image 132 occupies a portion of the third surface area for third pad printed area 130. In some embodiments, the third pad printed image 132 can occupy at least 20% of the third surface area. In some embodiments, the third pad printed image 132 can occupy at least 30% of the third surface area. In some embodiments, the third pad printed image 132 can occupy at least 50% of the third surface area. In some embodiments, the third pad printed image 132 can occupy an area greater than or equal to 20% of the third surface area to less than or equal to 90% of the third surface area. In some embodiments, the third pad printed image 132 can occupy an area greater than or equal to 20% of the third surface area to less than or equal to 80% of the third surface area. In some embodiments, the third pad printed image 132 can occupy an area greater than or equal to 20% of the third surface area to less than or equal to 70% of the third surface area. In some embodiments, the third pad printed image 132 can occupy an area greater than or equal to 20% of the third surface area to less than or equal to 60% of the third surface area. In some embodiments, the third pad printed image 132 can occupy an area greater than or equal to 20% of the third surface area to less than or equal to 50% of the third surface area. In some embodiments, the third pad printed image 132 can occupy an area greater than or equal to 30% of the third surface area to less than or equal to 90% of the third surface area. In some embodiments, the third pad printed image 132 can occupy an area greater than or equal to 50% of the third surface area to less than or equal to 90% of the third surface area.

Fourth pad printed area 140 can comprise a fourth surface area occupying at least 20% of the total surface area of golf ball 100. In some embodiments, the fourth surface area can occupy greater than or equal to 20% of the total surface area to less than or equal to 30% of the total surface area. In some embodiments, the fourth surface area can occupy greater than or equal to 22% of the total surface area to less than or equal to 30% of the total surface area. In some embodiments, the fourth surface area can occupy greater than or equal to 24% of the total surface area to less than or equal to 30% of the total surface area. In some embodiments, the fourth surface area can occupy greater than or equal to 20% of the total surface area to less than or equal to 28% of the total surface area. In some embodiments, the fourth surface area can occupy greater than or equal to 20% of the total surface area to less than or equal to 26% of the total surface area.

In some embodiments, the fourth surface area for fourth pad printed area 140 can comprise a surface area ranging from greater than or equal 1000 mm² to less than or equal to 2000 mm², including subranges. For example, in some embodiments, the fourth surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the fourth surface area for fourth pad printed area 140 can comprise a surface area ranging from greater than or equal 1400 mm² to less than or equal to 1500 mm².

Fourth pad printed image 142 occupies a portion of the fourth surface area for fourth pad printed area 140. In some embodiments, the fourth pad printed image 142 can occupy at least 20% of the fourth surface area. In some embodiments, the fourth pad printed image 142 can occupy at least 30% of the fourth surface area. In some embodiments, the fourth pad printed image 142 can occupy at least 50% of the fourth surface area. In some embodiments, the fourth pad printed image 142 can occupy an area greater than or equal to 20% of the fourth surface area to less than or equal to 90% of the fourth surface area. In some embodiments, the fourth pad printed image 142 can occupy an area greater than or equal to 20% of the fourth surface area to less than or equal to 80% of the fourth surface area. In some embodiments, the fourth pad printed image 142 can occupy an area greater than or equal to 20% of the fourth surface area to less than or equal to 70% of the fourth surface area. In some embodiments, the fourth pad printed image 142 can occupy an area greater than or equal to 20% of the fourth surface area to less than or equal to 60% of the fourth surface area. In some embodiments, the fourth pad printed image 142 can occupy an area greater than or equal to 20% of the fourth surface area to less than or equal to 50% of the fourth surface area. In some embodiments, the fourth pad printed image 142 can occupy an area greater than or equal to 30% of the fourth surface area to less than or equal to 90% of the fourth surface area. In some embodiments, the fourth pad printed image 142 can occupy an area greater than or equal to 50% of the fourth surface area to less than or equal to 90% of the fourth surface area.

Fifth pad printed area 150 can comprise a fifth surface area occupying at least 20% of the total surface area of golf ball 100. In some embodiments, the fifth surface area can occupy greater than or equal to 20% of the total surface area to less than or equal to 30% of the total surface area. In some embodiments, the fifth surface area can occupy greater than or equal to 22% of the total surface area to less than or equal to 30% of the total surface area. In some embodiments, the fifth surface area can occupy greater than or equal to 24% of the total surface area to less than or equal to 30% of the total surface area. In some embodiments, the fifth surface area can occupy greater than or equal to 20% of the total surface area to less than or equal to 28% of the total surface area. In some embodiments, the fifth surface area can occupy greater than or equal to 20% of the total surface area to less than or equal to 26% of the total surface area.

In some embodiments, the fifth surface area for fifth pad printed area 150 can comprise a surface area ranging from greater than or equal 1000 mm² to less than or equal to 2000 mm², including subranges. For example, in some embodiments, the fifth surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the fifth surface area for fifth pad printed area 150 can comprise a surface area ranging from greater than or equal 1400 mm² to less than or equal to 1500 mm².

Fifth pad printed image 152 occupies a portion of the fifth surface area for fifth pad printed area 150. In some embodiments, the fifth pad printed image 152 can occupy at least 20% of the fifth surface area. In some embodiments, the fifth pad printed image 152 can occupy at least 30% of the fifth surface area. In some embodiments, the fifth pad printed image 152 can occupy at least 50% of the fifth surface area. In some embodiments, the fifth pad printed image 152 can occupy an area greater than or equal to 20% of the fifth surface area to less than or equal to 90% of the fifth surface area. In some embodiments, the fifth pad printed image 152 can occupy an area greater than or equal to 20% of the fifth surface area to less than or equal to 80% of the fifth surface area. In some embodiments, the fifth pad printed image 152 can occupy an area greater than or equal to 20% of the fifth surface area to less than or equal to 70% of the fifth surface area. In some embodiments, the fifth pad printed image 152 can occupy an area greater than or equal to 20% of the fifth surface area to less than or equal to 60% of the fifth surface area. In some embodiments, the fifth pad printed image 152 can occupy an area greater than or equal to 20% of the fifth surface area to less than or equal to 50% of the fifth surface area. In some embodiments, the fifth pad printed image 152 can occupy an area greater than or equal to 30% of the fifth surface area to less than or equal to 90% of the fifth surface area. In some embodiments, the fifth pad printed image 152 can occupy an area greater than or equal to 50% of the fifth surface area to less than or equal to 90% of the fifth surface area.

Sixth pad printed area 160 can comprise a sixth surface area occupying at least 20% of the total surface area of golf ball 100. In some embodiments, the sixth surface area can occupy greater than or equal to 20% of the total surface area to less than or equal to 30% of the total surface area. In some embodiments, the sixth surface area can occupy greater than or equal to 22% of the total surface area to less than or equal to 30% of the total surface area. In some embodiments, the sixth surface area can occupy greater than or equal to 24% of the total surface area to less than or equal to 30% of the total surface area. In some embodiments, the sixth surface area can occupy greater than or equal to 20% of the total surface area to less than or equal to 28% of the total surface area. In some embodiments, the sixth surface area can occupy greater than or equal to 20% of the total surface area to less than or equal to 26% of the total surface area.

In some embodiments, the sixth surface area for sixth pad printed area 160 can comprise a surface area ranging from greater than or equal 1000 mm² to less than or equal to 2000 mm², including subranges. For example, in some embodiments, the sixth surface area can comprise a surface area ranging from greater than or equal 1000 mm² to less than or equal to 1800 mm², from greater than or equal 1000 mm² to less than or equal to 1600 mm², from greater than or equal 1000 mm² to less than or equal to 1400 mm², from greater than or equal 1200 mm² to less than or equal to 2000 mm², from greater than or equal 1400 mm² to less than or equal to 2000 mm², from greater than or equal 1600 mm² to less than or equal to 2000 mm², or from greater than or equal 1200 mm² to less than or equal to 1600 mm². In some embodiments, the sixth surface area for sixth pad printed area 160 can comprise a surface area ranging from greater than or equal 1400 mm² to less than or equal to 1500 mm².

Sixth pad printed image 162 occupies a portion of the sixth surface area for sixth pad printed area 160. In some embodiments, the sixth pad printed image 162 can occupy at least 20% of the sixth surface area. In some embodiments, the sixth pad printed image 162 can occupy at least 30% of the sixth surface area. In some embodiments, the sixth pad printed image 162 can occupy at least 50% of the sixth surface area. In some embodiments, the sixth pad printed image 162 can occupy an area greater than or equal to 20% of the sixth surface area to less than or equal to 90% of the sixth surface area. In some embodiments, the sixth pad printed image 162 can occupy an area greater than or equal to 20% of the sixth surface area to less than or equal to 80% of the sixth surface area. In some embodiments, the sixth pad printed image 162 can occupy an area greater than or equal to 20% of the sixth surface area to less than or equal to 70% of the sixth surface area. In some embodiments, the sixth pad printed image 162 can occupy an area greater than or equal to 20% of the sixth surface area to less than or equal to 60% of the sixth surface area. In some embodiments, the sixth pad printed image 162 can occupy an area greater than or equal to 20% of the sixth surface area to less than or equal to 50% of the sixth surface area. In some embodiments, the sixth pad printed image 162 can occupy an area greater than or equal to 30% of the sixth surface area to less than or equal to 90% of the sixth surface area. In some embodiments, the sixth pad printed image 162 can occupy an area greater than or equal to 50% of the sixth surface area to less than or equal to 90% of the sixth surface area.

In some embodiments, the first surface area for first pad printed area 110 and the second surface area for the second pad printed area 120 partially overlap in an overlap area 165. In such embodiments, a portion of the first pad printed image 112 can be located in the overlap area 165 and a portion of the second pad printed image 122 can be located in the overlap area 165.

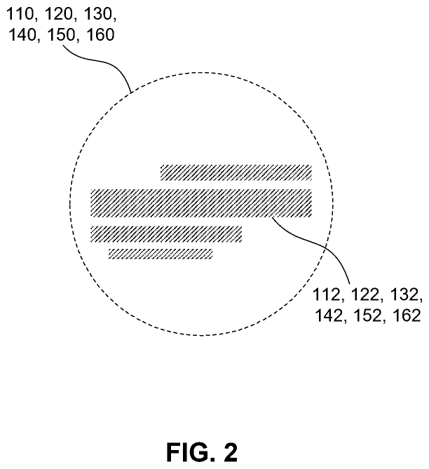

FIGS. 3A and 3B illustrate a first pad printed area 110 and a second pad printed area 120 partially overlapping in overlap area 165 according to some embodiments. As shown, a portion of the first pad printed image 112 is located in overlap area 165 and a portion of the second pad printed image 122 is located in overlap area 165. While FIGS. 3A and 3B illustrate overlap area 165, any other two pad printed areas can overlap in the same or similar way as illustrated in FIGS. 3A and 3B. For example, overlap areas 167, 169, 171, 173a-d, and 175a-d can be the same or similar as overlap area 165.

In some embodiments, overlap area 165 can have an overlap surface area greater than or equal to 5% of the first surface area. In some embodiments, overlap area 165 can have an overlap surface area greater than or equal to 5% of the first surface area to less than or equal to 50% of the first surface area. In some embodiments, overlap area 165 can have an overlap surface area greater than or equal to 10% of the first surface area to less than or equal to 50% of the first surface area. In some embodiments, overlap area 165 can have an overlap surface area greater than or equal to 20% of the first surface area to less than or equal to 50% of the first surface area. In some embodiments, overlap area 165 can have an overlap surface area greater than or equal to 30% of the first surface area to less than or equal to 50% of the first surface area. In some embodiments, overlap area 165 can have an overlap surface area greater than or equal to 5% of the first surface area to less than or equal to 40% of the first surface area. In some embodiments, overlap area 165 can have an overlap surface area greater than or equal to 10% of the first surface area to less than or equal to 40% of the first surface area. In some embodiments, overlap area 165 can have an overlap surface area greater than or equal to 20% of the first surface area to less than or equal to 40% of the first surface area. In some embodiments, overlap area 165 can have an overlap surface area greater than or equal to 30% of the first surface area to less than or equal to 40% of the first surface area.

In some embodiments, overlap area 165 can comprise a surface area ranging from greater than or equal 50 mm² to less than or equal to 800 mm², including subranges. For example, in some embodiments, the overlap area 165 can comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the first pad printed image 112 can be located in the overlap area 165 and at least 5% of the second pad printed image 122 can be located in the overlap area 165. In some embodiments, at least 10% of the first pad printed image 112 can be located in the overlap area 165 and at least 10% of the second pad printed image 122 can be located in the overlap area 165. In some embodiments, 5% to 50% of the first pad printed image 112 can be located in the overlap area 165 and 5% to 50% of the second pad printed image 122 can be located in the overlap area 165. In some embodiments, 10% to 50% of the first pad printed image 112 can be located in the overlap area 165 and 10% to 50% of the second pad printed image 122 can be located in the overlap area 165.

In some embodiments, the second surface area for second pad printed area 120 and the third surface area for the third pad printed area 130 partially overlap in an overlap area 167. In such embodiments, a portion of the second pad printed image 122 can be located in the overlap area 167 and a portion of the third pad printed image 132 can be located in the overlap area 167.

In some embodiments, overlap area 167 can have an overlap surface area greater than or equal to 5% of the second surface area. In some embodiments, overlap area 167 can have an overlap surface area greater than or equal to 5% of the second surface area to less than or equal to 50% of the second surface area. In some embodiments, overlap area 167 can have an overlap surface area greater than or equal to 10% of the second surface area to less than or equal to 50% of the second surface area. In some embodiments, overlap area 167 can have an overlap surface area greater than or equal to 20% of the second surface area to less than or equal to 50% of the second surface area. In some embodiments, overlap area 167 can have an overlap surface area greater than or equal to 30% of the second surface area to less than or equal to 50% of the second surface area. In some embodiments, overlap area 167 can have an overlap surface area greater than or equal to 5% of the second surface area to less than or equal to 40% of the second surface area. In some embodiments, overlap area 167 can have an overlap surface area greater than or equal to 10% of the second surface area to less than or equal to 40% of the second surface area. In some embodiments, overlap area 167 can have an overlap surface area greater than or equal to 20% of the second surface area to less than or equal to 40% of the second surface area. In some embodiments, overlap area 167 can have an overlap surface area greater than or equal to 30% of the second surface area to less than or equal to 40% of the second surface area.

In some embodiments, overlap area 167 can comprise a surface area ranging from greater than or equal 50 mm² to less than or equal to 800 mm², including subranges. For example, in some embodiments, the overlap area 167 can comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the second pad printed image 122 can be located in the overlap area 167 and at least 5% of the third pad printed image 132 can be located in the overlap area 167. In some embodiments, at least 10% of the second pad printed image 122 can be located in the overlap area 167 and at least 10% of the third pad printed image 132 can be located in the overlap area 167. In some embodiments, 5% to 50% of the second pad printed image 122 can be located in the overlap area 167 and 5% to 50% of the third pad printed image 132 can be located in the overlap area 167. In some embodiments, 10% to 50% of the second pad printed image 122 can be located in the overlap area 167 and 10% to 50% of the third pad printed image 132 can be located in the overlap area 167.

In some embodiments, the third surface area for third pad printed area 130 and the fourth surface area for the fourth pad printed area 140 partially overlap in an overlap area 169. In such embodiments, a portion of the third pad printed image 132 can be located in the overlap area 169 and a portion of the fourth pad printed image 142 can be located in the overlap area 169.

In some embodiments, overlap area 169 can have an overlap surface area greater than or equal to 5% of the third surface area. In some embodiments, overlap area 169 can have an overlap surface area greater than or equal to 5% of the third surface area to less than or equal to 50% of the third surface area. In some embodiments, overlap area 169 can have an overlap surface area greater than or equal to 10% of the third surface area to less than or equal to 50% of the third surface area. In some embodiments, overlap area 169 can have an overlap surface area greater than or equal to 20% of the third surface area to less than or equal to 50% of the third surface area. In some embodiments, overlap area 169 can have an overlap surface area greater than or equal to 30% of the third surface area to less than or equal to 50% of the third surface area. In some embodiments, overlap area 169 can have an overlap surface area greater than or equal to 5% of the third surface area to less than or equal to 40% of the third surface area. In some embodiments, overlap area 169 can have an overlap surface area greater than or equal to 10% of the third surface area to less than or equal to 40% of the third surface area. In some embodiments, overlap area 169 can have an overlap surface area greater than or equal to 20% of the third surface area to less than or equal to 40% of the third surface area. In some embodiments, overlap area 169 can have an overlap surface area greater than or equal to 30% of the third surface area to less than or equal to 40% of the third surface area.

In some embodiments, overlap area 169 can comprise a surface area ranging from greater than or equal 50 mm² to less than or equal to 800 mm², including subranges. For example, in some embodiments, the overlap area 169 can comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the third pad printed image 132 can be located in the overlap area 169 and at least 5% of the fourth pad printed image 142 can be located in the overlap area 169. In some embodiments, at least 10% of the third pad printed image 132 can be located in the overlap area 169 and at least 10% of the fourth pad printed image 142 can be located in the overlap area 169. In some embodiments, 5% to 50% of the third pad printed image 132 can be located in the overlap area 169 and 5% to 50% of the fourth pad printed image 142 can be located in the overlap area 169. In some embodiments, 10% to 50% of the third pad printed image 132 can be located in the overlap area 169 and 10% to 50% of the fourth pad printed image 142 can be located in the overlap area 169.

In some embodiments, the fourth surface area for fourth pad printed area 140 and the first surface area for the first pad printed area 110 partially overlap in an overlap area 171. In such embodiments, a portion of the fourth pad printed image 142 can be located in the overlap area 171 and a portion of the first pad printed image 112 can be located in the overlap area 171.

In some embodiments, overlap area 171 can have an overlap surface area greater than or equal to 5% of the fourth surface area. In some embodiments, overlap area 171 can have an overlap surface area greater than or equal to 5% of the fourth surface area to less than or equal to 50% of the fourth surface area. In some embodiments, overlap area 171 can have an overlap surface area greater than or equal to 10% of the fourth surface area to less than or equal to 50% of the fourth surface area. In some embodiments, overlap area 171 can have an overlap surface area greater than or equal to 20% of the fourth surface area to less than or equal to 50% of the fourth surface area. In some embodiments, overlap area 171 can have an overlap surface area greater than or equal to 30% of the fourth surface area to less than or equal to 50% of the fourth surface area. In some embodiments, overlap area 171 can have an overlap surface area greater than or equal to 5% of the fourth surface area to less than or equal to 40% of the fourth surface area. In some embodiments, overlap area 171 can have an overlap surface area greater than or equal to 10% of the fourth surface area to less than or equal to 40% of the fourth surface area. In some embodiments, overlap area 171 can have an overlap surface area greater than or equal to 20% of the fourth surface area to less than or equal to 40% of the fourth surface area. In some embodiments, overlap area 171 can have an overlap surface area greater than or equal to 30% of the fourth surface area to less than or equal to 40% of the fourth surface area.

In some embodiments, overlap area 171 can comprise a surface area ranging from greater than or equal 50 mm² to less than or equal to 800 mm², including subranges. For example, in some embodiments, the overlap area 171 can comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the fourth pad printed image 142 can be located in the overlap area 171 and at least 5% of the first pad printed image 112 can be located in the overlap area 171. In some embodiments, at least 10% of the fourth pad printed image 142 can be located in the overlap area 171 and at least 10% of the first pad printed image 112 can be located in the overlap area 171. In some embodiments, 5% to 50% of the fourth pad printed image 142 can be located in the overlap area 171 and 5% to 50% of the first pad printed image 112 can be located in the overlap area 171. In some embodiments, 10% to 50% of the fourth pad printed image 142 can be located in the overlap area 171 and 10% to 50% of the first pad printed image 112 can be located in the overlap area 171.

In some embodiments, golf ball 100 can comprise two or more of overlap areas 165, 167, 169, and 171. In some embodiments, golf ball 100 can comprise three or more of overlap areas 165, 167, 169, and 171. In some embodiments, golf ball 100 can comprise all four overlap areas 165, 167, 169, and 171, for example, as shown in FIG. 5.

In some embodiments, the fifth surface area for fifth pad printed area 150 can partially overlap with the surface area of each of pad printed areas 110, 120, 130 and 140 in an overlap areas 173a-d. In some embodiments, a portion of the fifth pad printed image 152 can be located in overlap area 173a and a portion of the first pad printed image 112 can be located in the overlap area 173a. In some embodiments, a portion of the fifth pad printed image 152 can be located in overlap area 173b and a portion of the second pad printed image 122 can be located in the overlap area 173b. In some embodiments, a portion of the fifth pad printed image 152 can be located in overlap area 173c and a portion of the third pad printed image 132 can be located in the overlap area 173c. In some embodiments, a portion of the fifth pad printed image 152 can be located in overlap area 173d and a portion of the fourth pad printed image 142 can be located in the overlap area 173d.

In some embodiments, individual overlap areas 173a-d can have an overlap surface area greater than or equal to 5% of the fifth surface area. In some embodiments, individual overlap areas 173a-d can have an overlap surface area greater than or equal to 5% of the fifth surface area to less than or equal to 50% of the fifth surface area. In some embodiments, individual overlap areas 173a-d can have an overlap surface area greater than or equal to 10% of the fifth surface area to less than or equal to 50% of the fifth surface area. In some embodiments, individual overlap areas 173a-d can have an overlap surface area greater than or equal to 20% of the fifth surface area to less than or equal to 50% of the fifth surface area. In some embodiments, individual overlap areas 173a-d can have an overlap surface area greater than or equal to 30% of the fifth surface area to less than or equal to 50% of the fifth surface area. In some embodiments, individual overlap areas 173a-d can have an overlap surface area greater than or equal to 5% of the fifth surface area to less than or equal to 40% of the fifth surface area. In some embodiments, individual overlap areas 173a-d can have an overlap surface area greater than or equal to 10% of the fifth surface area to less than or equal to 40% of the fifth surface area. In some embodiments, individual overlap areas 173a-d can have an overlap surface area greater than or equal to 20% of the fifth surface area to less than or equal to 40% of the fifth surface area. In some embodiments, individual overlap areas 173a-d can have an overlap surface area greater than or equal to 30% of the fifth surface area to less than or equal to 40% of the fifth surface area.

In some embodiments, individual overlap areas 173a-d can comprise a surface area ranging from greater than or equal 50 mm² to less than or equal to 800 mm², including subranges. For example, in some embodiments, individual overlap areas 173a-d can comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the fifth pad printed image 152 can be located in an overlap area 173a-d and at least 5% of the first, second, third, or fourth pad printed image 112, 122, 132, 142 can be located in the overlap area 173a-d. In some embodiments, at least 10% of the fifth pad printed image 152 can be located in an overlap area 173a-d and at least 10% of the first, second, third, or fourth pad printed image 112, 122, 132, 142 can be located in the overlap area 173a-d. In some embodiments, 5% to 50% of the fifth pad printed image 152 can be located in an overlap area 173a-d and 5% to 50% of the first, second, third, or fourth pad printed image 112, 122, 132, 142 can be located in the overlap area 173a-d. In some embodiments, 10% to 50% of the fifth pad printed image 152 can be located in an overlap area 173a-d and 10% to 50% of the first, second, third, or fourth pad printed image 112, 122, 132, 142 can be located in the overlap area 173a-d.

In some embodiments, the sixth surface area for sixth pad printed area 160 can partially overlap with the surface area of each of pad printed areas 110, 120, 130 and 140 in an overlap areas 175a-d. In some embodiments, a portion of the sixth pad printed image 162 can be located in overlap area 175a and a portion of the first pad printed image 112 can be located in the overlap area 175a. In some embodiments, a portion of the sixth pad printed image 162 can be located in overlap area 175b and a portion of the second pad printed image 122 can be located in the overlap area 175b. In some embodiments, a portion of the sixth pad printed image 162 can be located in overlap area 175c and a portion of the third pad printed image 132 can be located in the overlap area 175c. In some embodiments, a portion of the sixth pad printed image 162 can be located in overlap area 175d and a portion of the fourth pad printed image 142 can be located in the overlap area 175d.

In some embodiments, individual overlap areas 175a-d can have an overlap surface area greater than or equal to 5% of the sixth surface area. In some embodiments, individual overlap areas 175a-d can have an overlap surface area greater than or equal to 5% of the sixth surface area to less than or equal to 50% of the sixth surface area. In some embodiments, individual overlap areas 175a-d can have an overlap surface area greater than or equal to 10% of the sixth surface area to less than or equal to 50% of the sixth surface area. In some embodiments, individual overlap areas 175a-d can have an overlap surface area greater than or equal to 20% of the sixth surface area to less than or equal to 50% of the sixth surface area. In some embodiments, individual overlap areas 175a-d can have an overlap surface area greater than or equal to 30% of the sixth surface area to less than or equal to 50% of the sixth surface area. In some embodiments, individual overlap areas 175a-d can have an overlap surface area greater than or equal to 5% of the sixth surface area to less than or equal to 40% of the sixth surface area. In some embodiments, individual overlap areas 175a-d can have an overlap surface area greater than or equal to 10% of the sixth surface area to less than or equal to 40% of the sixth surface area. In some embodiments, individual overlap areas 175a-d can have an overlap surface area greater than or equal to 20% of the sixth surface area to less than or equal to 40% of the sixth surface area. In some embodiments, individual overlap areas 175a-d can have an overlap surface area greater than or equal to 30% of the sixth surface area to less than or equal to 40% of the sixth surface area.

In some embodiments, individual overlap areas 175a-d can comprise a surface area ranging from greater than or equal 50 mm² to less than or equal to 800 mm², including subranges. For example, in some embodiments, individual overlap areas 175a-dcan comprise a surface area ranging from greater than or equal 50 mm² to less than or equal to 700 mm², from greater than or equal 50 mm² to less than or equal to 600 mm², from greater than or equal 100 mm² to less than or equal to 800 mm², from greater than or equal 200 mm² to less than or equal to 800 mm², from greater than or equal 300 mm² to less than or equal to 800 mm², or from greater than or equal 500 mm² to less than or equal to 600 mm².

In some embodiments, at least 5% of the sixth pad printed image 162 can be located in an overlap area 175a-d and at least 5% of the first, second, third, or fourth pad printed image 112, 122, 132, 142 can be located in the overlap area 175a-d. In some embodiments, at least 10% of the sixth pad printed image 162 can be located in an overlap area 175a-d and at least 10% of the first, second, third, or fourth pad printed image 112, 122, 132, 142 can be located in the overlap area 175a-d. In some embodiments, 5% to 50% of the sixth pad printed image 162 can be located in an overlap area 175a-d and 5% to 50% of the first, second, third, or fourth pad printed image 112, 122, 132, 142 can be located in the overlap area 175a-d. In some embodiments, 10% to 50% of the sixth pad printed image 162 can be located in an overlap area 175a-d and 10% to 50% of the first, second, third, or fourth pad printed image 112, 122, 132, 142 can be located in the overlap area 175a-d.

In some embodiments, three pad printed areas 110, 120, 130, 140, 150, 160 can partially overlap in an overlap area 177. In some embodiments, first, second, and fifth areas 110, 120, 150 can overlap in an overlap area 177. In some embodiments, second, third, and fifth areas 120, 130, 150 can overlap in an overlap area 177. In some embodiments, third, fourth, and fifth areas 130, 140, 150 can overlap in an overlap area 177. In some embodiments, fourth, first, and fifth areas 140, 110, 150 can overlap in an overlap area 177. In some embodiments, first, second, and sixth areas 110, 120, 160 can overlap in an overlap area 177. In some embodiments, second, third, and sixth areas 120, 130, 160 can overlap in an overlap area 177. In some embodiments, third, fourth, and sixth areas 130, 140, 160 can overlap in an overlap area 177. In some embodiments, fourth, first, and sixth areas 140, 110, 160 can overlap in an overlap area 177.

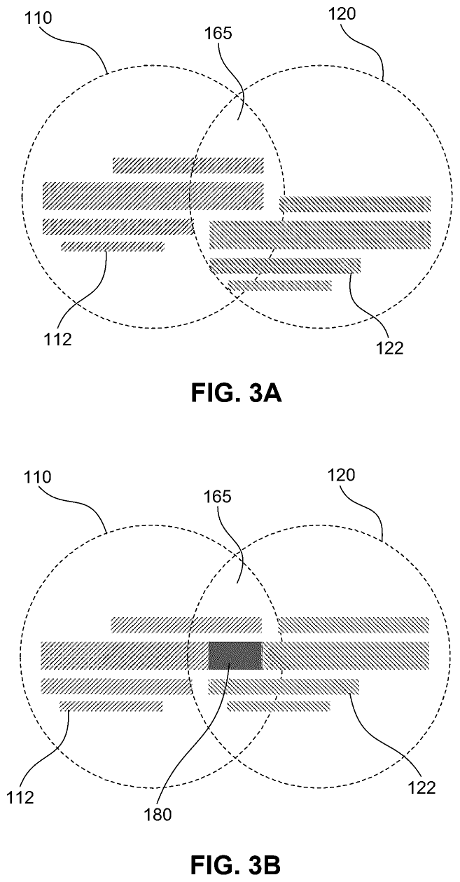

In embodiments comprising one or more overlap areas 177, a portion of each of the three pad printed images in the three overlapping areas can be located in the overlap area 177. For example, as illustrated in FIG. 4, a portion of the first pad printed image 112 can located in an overlap area 177, a portion of the second pad printed image 122 can located in the overlap area 177, and a portion of the fifth pad printed image 152 can be located in the overlap area 177.

In some embodiments, an overlap area 177 can have an overlap surface area greater than or equal to 5% of the surface area for any one of the three pad printed areas that overlap in the overlap area 177. For example, for an overlap area 177 comprising the first, second, and fifth areas 110, 120, 150, the overlap area 177 can have an overlap surface area greater than or equal to 5% of the first surface area for first pad printed area 110. In some embodiments, an overlap area 177 can have an overlap surface area greater than or equal to 5% to less than or equal 15% of the surface area for any one of the three pad printed areas that overlap in the overlap area 177. For example, for an overlap area 177 comprising the first, second, and fifth areas 110, 120, 150, the overlap area 177 can have an overlap surface area greater than or equal to 5% to less than or equal to 15% of the first surface area for first pad printed area 110.

In some embodiments, an individual overlap area 177 can comprise a surface area ranging from greater than or equal 20 mm² to less than or equal to 200 mm², including subranges. For example, in some embodiments, an individual overlap area 177 can comprise a surface area ranging from greater than or equal 20 mm² to less than or equal to 175 mm², from greater than or equal 20 mm² to less than or equal to 150 mm², from greater than or equal 40 mm² to less than or equal to 200 mm², from greater than or equal 60 mm² to less than or equal to 200 mm², from greater than or equal 100 mm² to less than or equal to 200 mm², or from greater than or equal 100 mm² to less than or equal to 150 mm².

In some embodiments, at least 10% of the total surface area of the golf ball 100 can be occupied by three of the pad printed areas. In other words, at least 10% of the total surface area of the golf ball 100 can be occupied by overlap areas 177. In some embodiments, greater or equal to 10% to less than or equal to 25% of the total surface area of the golf ball 100 can be occupied by three of the pad printed areas. In other words, greater or equal to 10% to less than or equal to 25% of the golf ball 100 can be occupied by overlap areas 177. In some embodiments, greater or equal to 15% to less than or equal to 20% of the total surface area of the golf ball 100 can be occupied by three of the pad printed areas.

In some embodiments, at least 70% of the total surface area of the golf ball 100 can be occupied by at least two of the pad printed areas. In other words, at least 70% of the total surface area of the golf ball 100 can be occupied by overlap areas 165, 167, 169, 171, 173a-d, and 175a-d. In some embodiments, greater or equal to 70% to less than or equal to 85% of the total surface area of the golf ball 100 can be occupied by at least two of the pad printed areas. In other words, greater or equal to 70% to less than or equal to 85% of the golf ball 100 can be occupied by overlap areas 165, 167, 169, 171, 173a-d, and 175a-d. In some embodiments, greater or equal to 70% to less than or equal to 80% of the total surface area of the golf ball 100 can be occupied by at least two of the pad printed areas.

In some embodiments, a first pad printed area (for example, first pad printed area 110) can contain at least one first color and a second pad printed area (for example, second pad printed area 120) can contain a second color that is different from the first color. The respective colors from the first and second pad printed areas can be located in an overlap area (for example, overlap area 165). In some embodiments, the colors can overlap on top of each other. In some embodiments, the colors can be interlaced to form an intended image, but not overlapped. In some embodiments, the colors can overlap on top of each other and are interlaced.

In some embodiments, at least three overlap areas, or three to twelve overlap areas, can be located on the ball 100 where each overlap area contains an image or design that is created by the different color from each respective pad printed area 110, 120, 130, 140, 150, 160 that overlaps in the overlap areas. In some embodiments, at least two overlap areas, or two to twelve overlap areas, can be located on the ball 100 where each overlap area contains an image or design that is created by the different color from each respective pad printed area 110, 120, 130, 140, 150, 160 that overlaps in the overlap areas. In some embodiments, at least four overlap areas, or four to twelve overlap areas, can be located on the ball 100 where each overlap area contains an image or design that is created by the different color from each respective pad printed area 110, 120, 130, 140, 150, 160 that overlaps in the overlap areas. In some embodiments, at least five overlap areas, or five to twelve overlap areas, can be located on the ball 100 where each overlap area contains an image or design that is created by the different color from each respective pad printed area 110, 120, 130, 140, 150, 160 that overlaps in the overlap areas. In some embodiments, at least six overlap areas, or six to twelve overlap areas, can be located on the ball 100 where each overlap area contains an image or design that is created by the different color from each respective pad printed area 110, 120, 130, 140, 150, 160 that overlaps in the overlap areas. In some embodiments, at least seven overlap areas, or seven to twelve overlap areas, can be located on the ball 100 where each overlap area contains an image or design that is created by the different color from each respective pad printed area 110, 120, 130, 140, 150, 160 that overlaps in the overlap areas. In some embodiments, at least eight overlap areas, or eight to twelve overlap areas, can be located on the ball 100 where each overlap area contains an image or design that is created by the different color from each respective pad printed area 110, 120, 130, 140, 150, 160 that overlaps in the overlap areas. In some embodiments, at least nine overlap areas, or nine to twelve overlap areas, can be located on the ball 100 where each overlap area contains an image or design that is created by the different color from each respective pad printed area 110, 120, 130, 140, 150, 160 that overlaps in the overlap areas. In some embodiments, at least ten overlap areas, or ten to twelve overlap areas, can be located on the ball 100 where each overlap area contains an image or design that is created by the different color from each respective pad printed area 110, 120, 130, 140, 150, 160 that overlaps in the overlap areas. In some embodiments, at least eleven overlap areas, or eleven to twelve overlap areas, can be located on the ball 100 where each overlap area contains an image or design that is created by the different color from each respective pad printed area 110, 120, 130, 140, 150, 160 that overlaps in the overlap areas.

Any of the embodiments described herein can have more than one color in each pad printed area. Therefore, in some embodiments, two colors in a first pad printed area (for example, the first pad printed area 110) can interact with two different colors from a second pad printed area (for example, the second pad printed area 120) to form a design or image that has four colors located in an overlap area (for example, overlap area 165). The image or design in each overlap area can have at least two colors, at least three colors, at least four colors, at least five colors, at least six colors, or up to one hundred colors or more. For example, in some embodiments, a first pad printed area (for example, first pad printed area 110) can have two colors while a second pad printed area (for example, second pad printed area 120) can have only one color, but they combine to create a three-color image in an overlap area (for example, overlap area 165). In some embodiments, one pad printed area can have more colors than another pad printed area with which it creates an overlapping area.

In some embodiments where at least a portion of an image or design is located in an overlap area, a golf ball having at least one to three colors in each of six printing zones where at least one color is different between two of the six printing zones is contemplated.

A color for a graphic or image can be, for example, red, crimson, maroon, magenta, pink, orange, yellow, gold, chartreuse, green, blue, navy, aqua, teal, cerulean, indigo, violet, purple, brown, black, grey, white, beige, silver, taupe, or various shades of these colors.

A color can be described with respect to CIELab color space using L*a*b* color values or L*C*h color values, but other color descriptions can be used. As used herein, L* is referred to as lightness, a* and b* are referred to as chromaticity coordinates, C* is referred to as chroma, and h is referred to as hue. In the CIELab color space, +a* is a red direction, −a* is a green direction, +b* is a yellow direction, and −b* is the blue direction. L* has a value of 100 for a perfect white diffuser. Chroma and hue are polar coordinates associated with a* and b*, wherein chroma (C*) is a distance from the axis along which a*=b*=0 and hue is an angle measured counterclockwise from the +a* axis.

In some embodiments, a yellow color can have L, a, and b values within the following ranges: L=80-95; a=−20-5; and b=45-110. For example, in some embodiments, an orange color can have L, a, and b values within the following ranges: L=50-90; a=5-65; and b=40-95. As another example, in some embodiments, a red color can have L, a, and b values within the following ranges: L=35-85; a=25-80; and b=−50-55. As another example, in some embodiments, a violet color can have L, a, and b values within the following ranges: L=15-80; a=20-80; and b=−65-0. In some embodiments, a blue color can have L, a, and b values within the following ranges: L=10-90; a=-55-55; and b=−75-−10. As another example, in some embodiments, a green color can have L, a, and b values within the following ranges: L=25-90; a=−85-−15; and b=−15-85.

In some embodiments, a first color can be selected from the group of: red, crimson, maroon, magenta, pink, orange, yellow, gold, chartreuse, green, blue, navy, aqua, teal, cerulean, indigo, violet, purple, brown, black, grey, white, beige, silver, or taupe. In some embodiments, a second color can be selected from the group of: red, crimson, maroon, magenta, pink, orange, yellow, gold, chartreuse, green, blue, navy, aqua, teal, cerulean, indigo, violet, purple, brown, black, grey, white, beige, silver, or taupe.

Two colors are considered different if there is any detectable color difference between the first color and the second color. In some embodiments, a first color described as being different from a second color has one or more of a lightness value, a chroma value, or a hue value that is at least 1% higher or at least 1% lower than the lightness value, chroma value, and hue value the second color. In some embodiments, the first color can have a lightness value of at least 1% higher or at least 1% lower than the lightness value of the second color. In some embodiments, the first color can have a chroma value of at least 1% higher or at least 1% lower than the chroma value of the second color. In some embodiments, the first color can have a hue value of at least 1% higher or at least 1% lower than the hue value of the second color.

In some embodiments, a first color described as being different from a second color has one or more of a lightness value, a chroma value, or a hue value that is at least 5% higher or at least 5% lower than the lightness value, chroma value, and hue value the second color. In some embodiments, the first color can have a lightness value of at least 5% higher or at least 5% lower than the lightness value of the second color. In some embodiments, the first color can have a chroma value of at least 5% higher or at least 5% lower than the chroma value of the second color. In some embodiments, the first color can have a hue value of at least 5% higher or at least 5% lower than the hue value of the second color.

In some embodiments, a first color described as being different from a second color has one or more of a lightness value, a chroma value, or a hue value that is at least 10% higher or at least 10% lower than the lightness value, chroma value, and hue value the second color. In some embodiments, the first color can have a lightness value of at least 10% higher or at least 10% lower than the lightness value of the second color. In some embodiments, the first color can have a chroma value of at least 10% higher or at least 10% lower than the chroma value of the second color. In some embodiments, the first color can have a hue value of at least 10% higher or at least 10% lower than the hue value of the second color.

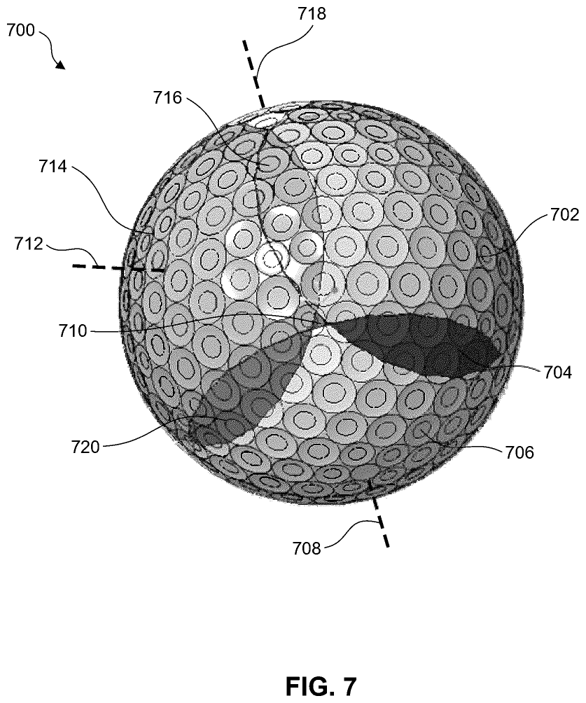

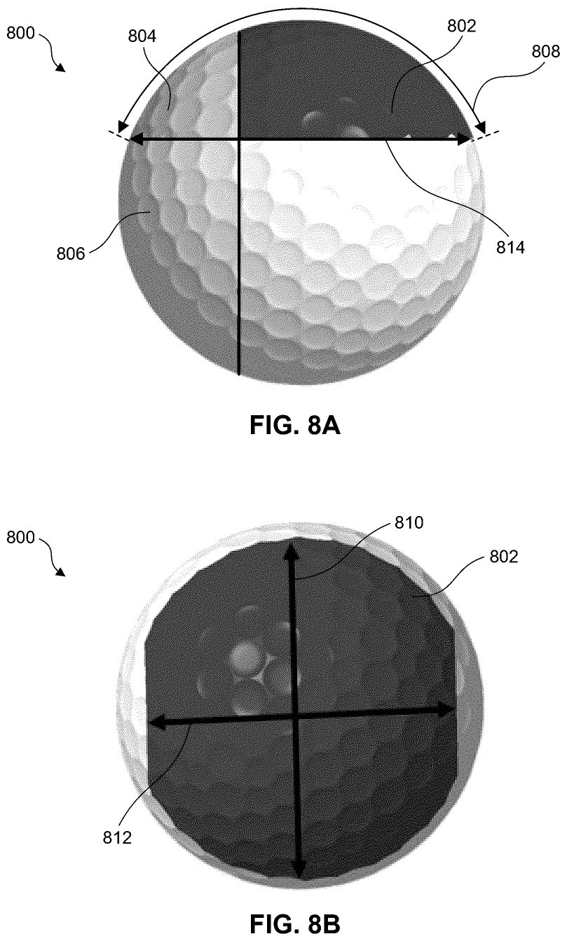

As a non-limiting example, a golf ball 100 having a 42.77-mm diameter was modeled as having pad printed areas 110, 120 130, 140, 150, and 160, each having a surface area of 1438.85 mm² printed with a pad configured to print a 40-mm printed planar diameter area on the ball with a 51.7 mm printed arc diameter. The terms printed arc diameter and printed planar diameter as used herein are shown in FIGS. 8A and 8B, for illustration purposes. That said, any pad printed area according to any embodiment described herein can have a printed arc diameter and printed planar diameter as described herein.

In FIG. 8A, the golf ball 800 is shown having a first pad printed area 802 and a second pad printed area 806 and an overlap pad printed area 804 that contains an image or design composed of ink applied in the first pad printed area 802 and second pad printed area 806. The printed arc diameter 808 of the first pad printed area 802 is shown as the diameter of the circle along the surface of the golf ball (not including dimple undulations but measured as if the ball did not have dimples). As noted herein, the first pad printed area is not necessarily the region where ink is applied but rather the region where the pad makes physical contact with the ball in the printing process and a region where ink could theoretically be applied in a given pad contact with the golf ball 800. In practice, in order to determine the first pad printed area 802 edges to evaluate the printed arc diameter 808, ink can be applied to the entire surface of the pad used for printing and then applied to the golf ball. After doing so, the resulting circular or non-circular image can be evaluated to determine the printed arc diameter and any other required measurements described herein. A printed planar diameter 814 is also shown in FIG. 8A. The printed planar diameter 814 is not measured along the surface of the ball but rather within a plane that substantially includes the edges of the first pad printed area 802. It is understood that the printed planar diameter 814 can be calculated if the printed arc diameter 808 and overall ball diameter are already known. In some embodiments, the printed arc diameter 808 can be between 28 mm and 68 mm, between 29 and 60 mm, between 30 mm and 55 mm, between 31 mm and 50 mm, between 31 mm and 45 mm, or between 31 mm and 40 mm. In some embodiments, the printed planar diameter can be between 26 mm and 43 mm, between 26 and 42 mm, between 27 mm and 41 mm, between 28 mm and 40 mm, between 28 mm and 37 mm, or between 28 mm and 34 mm. In instances where a printed planar diameter is required on a non-circular printed area, a best-fit printed planar diameter can be used to find the maximum printed planar diameter for a given shape.

FIG. 8B shows a golf ball 800 having a non-circular first pad printed area 802. In this instance, a printed arc diameter can be difficult to determine. Therefore, a maximum printed arc length 810 and maximum printed arc width 812 is utilized instead of the printed arc diameter. In some embodiments, the maximum printed arc length 810 can be between 28 mm and 68 mm, between 29 and 60 mm, between 30 mm and 55 mm, between 31 mm and 50 mm, between 31 mm and 45 mm, between 31 mm and 40 mm, or between 34 mm and 47 mm. In some embodiments, the maximum printed arc width 812 can be between 28 mm and 58 mm, between 29 and 50 mm, between 30 mm and 45 mm, between 31 mm and 50 mm, between 31 mm and 45 mm, between 31 mm and 40 mm, or between 28 mm and 40 mm.

The images or designs located on golf balls described herein can comprise four to twelve images on a ball or can comprise twelve to fifty images on a ball, not including the logo or side stamp of the ball. A plurality of those images can be located in the overlap area but, in some embodiments, a majority of such images can be located in the non-overlap area.

Table 1 below shows the various areas covered by modeled areas 110, 120 130, 140, 150, and 160, as well as areas covered by overlap areas according to some embodiments.

TABLE 1

| | Example #1 | |
|---|---|---|
| | | % of Total Ball |
| Measurement | | Surface Area |
| Ball Diameter (mm) | 42.77 | — |
| Printed Planar Diameter (mm) | 40 | — |
| Printed Arc Diameter (mm) | 51.7 | |
| Area Covered by 3 Pads Total (mm²) | 1082.06 | 18.80% |
| Area Covered by at least 2 pads Total (mm²) | 4307.98 | 75.00% |
| Area Covered by Only 2 Pads Total (mm²) | 3225.91 | 56.10% |
| Area Covered by 1 Pad Only Total (mm²) | 1438.85 | 25.00% |
| Total Ball Surface Area (mm²) | 5746.82 | 100% |
| Area of overlap for exactly 2 pads | 539.35 | 9.39% |
| Area of overlap for exactly 3 pads | 135.25 | 2.35% |

With respect to Table 1, the ball diameter can be between 42 mm and 43 mm. The area covered by three pads total can be between 1% and 30%, between 5% and 25%, between 10% and 20% or between 15% and 20% of the entire outer surface area of the golf ball, including dimples. The area covered by at least two pads total (which includes three-pad coverage) can be between 50% and 85%, between 55% and 80%, between 60% and 80%, or between 70% and 80% of the entire outer surface area of the golf ball, including dimples. The area covered by two pads total (which does not include three-pad coverage) can be between 40% and 75%, between 45% and 70%, between 50% and 60%, or between 55% and 60% of the entire outer surface area of the golf ball, including dimples. The area covered by one pad total (which does not include two-or three-pad coverage) can be between 10% and 50%, between 15% and 40%, between 20% and 30%, or between 25% and 30% of the entire outer surface area of the golf ball, including dimples.

The total surface area of the ball can range from between 5700 mm² and 5800 mm², or between 5750 mm² and 5800 mm². In some embodiments, the area of overlap covered by exactly two pads can be between 1% and 45%, between 5% and 40%, between 7% and 30%, or between 8% and 20% of the entire outer surface area of the golf ball, including dimples. In some embodiments, the area of overlap covered by exactly three pads can be between 0% and 10%, between 1% and 8%, between 1% and 7%, or between 1% and 6% of the entire outer surface area of the golf ball, including dimples.

In some embodiments, in an overlap area, no ink defining a first pad printed image located in the overlap area overlaps ink defining a second pad printed image. For example, as shown in FIG. 3A, no ink defining first pad printed image 112 located in overlap area 165 overlaps ink defining second pad printed image 122 located in overlap area 165. While FIG. 3A illustrates first overlap area 165 with no overlapping ink, any of overlap areas 167, 169, 171, 173a-d, and/or 175a-d can similarly comprise two pad printed images where no ink defining one of the pad printed images located in the overlap area overlaps ink defining the other pad printed image.

In some embodiments, in an overlap area 177, no ink defining a first pad printed image located in the overlap area 177 overlaps ink defining a second pad printed image or a third pad printed image located in overlap area 177. For example, as shown in FIG. 4, no ink defining first pad printed image 112 located in overlap area 177 overlaps ink defining second pad printed image 122 located in overlap area 177 and no ink defining first pad printed image 112 located in overlap area 177 overlaps ink defining fifth pad printed image 152 located in overlap area 177. Similarly, no ink defining second pad printed image 122 located in overlap area 177 overlaps ink defining fifth pad printed image 152 located in overlap area 177.

By designing pad printed images defined by ink that does not overlap in overlap areas, a graphic 104 can be pad printed without visually noticeable seams in portions of the graphic 104 located within the overlap areas.

In some embodiments, in an overlap area, a first pad printed image can comprise (i) a first part where ink defining the first pad printed image does not overlap ink defining the second pad printed image and (ii) a second part where ink defining the first pad printed image overlaps ink defining the second pad printed image in one or more image overlap areas 180. For example, as shown in FIG. 3B, in overlap area 165, first pad printed image 112 can comprise (i) a first part where ink defining the first pad printed image 112 does not overlap ink defining the second pad printed image 122 and (ii) a second part where ink defining the first pad printed image 112 overlaps ink defining the second pad printed image 122 in an image overlap area 180. While FIG. 3B illustrates first overlap area 165 with overlapping ink in an image overlap area 180, any of overlap areas 167, 169, 171, 173a-d, and/or 175a-d can similarly comprise two pad printed images with overlapping ink in one or more image overlap areas 180.

In embodiments comprising an image overlap area 180, the first part of the first pad printed image can comprise a first ink density and the second part of the first pad printed image located in area 180 can comprise a second ink density less than the first ink density. In some embodiments, the second ink density can be 40% to 60% of the first ink density. Additionally, in embodiments comprising an image overlap area 180, the ink defining the second pad printed image in the image overlap area 180 can comprise a third ink density less than the first ink density. In some embodiments, the third ink density can 40% to 60% of the first ink density. In some embodiments, the sum of the second ink density and the third ink density can equal the first ink density.

By pad printing such that ink defining portions of graphic 104 that overlap in image overlap areas 180 as described herein, the appearance of seams in portions of the graphic 104 located within the overlap areas can be limited or prevented. In some embodiments, the first, second, and third ink densities can be controlled by the design of engraved areas of printing plates used to print images. In some embodiments, the first, second, and third ink densities can be controlled by the depth of engraved areas of printing plates used to print images. In some embodiments, engraved areas of printing plates used to print images can have stippled regions configured to set the second and third ink densities to less than the first ink density.

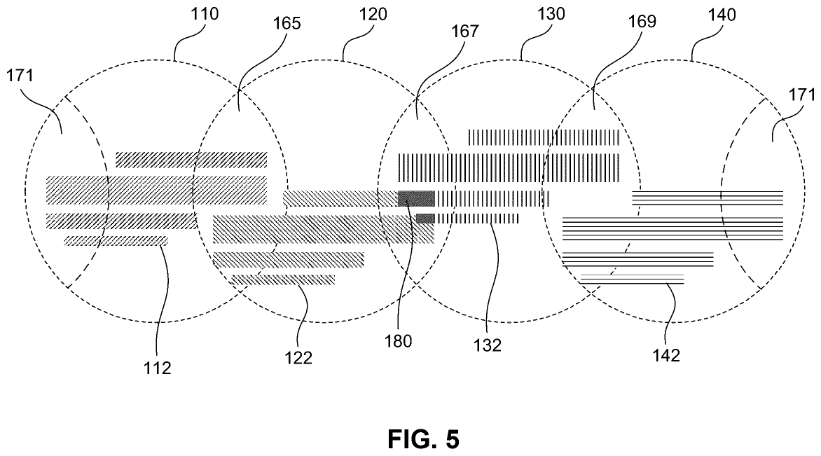

Graphics 104 as described herein can be printed by sequentially printing two or more of pad printed areas 110, 120, 130, 140, 150, 160 with pad printed images 112, 122, 132, 142, 152, 162. FIG. 6 illustrates an exemplary pad printing system 600 for printing a graphic 104. Pad printing system 600 comprises a number of pad printing stations for pad printing images 112, 122, 132, 142, 152, 162. FIG. 6 illustrates two pad printing stations 610 and 620. That said, system 600 can comprise any number of pad printing stations required to print a graphic 104. Each pad printing station can comprise a pad transfer mechanism, an ink cup or reservoir, a cliche plate, a support plate, and an excess ink removal device. In system 600, golf ball 100 moves along a linear direction 602 as it passes below adjacent printing stations.

The images located on a golf ball (for example ball 100 or ball 700) can be pre-distorted in a two-dimensional plane so that when they are applied to the three dimensional surface of the golf ball 100, 700, the images are not distorted, but rather create the intended visual image. For example, a first cliché plate can have a first pre-distorted image to be printed in a first pad printed area. A second cliché plate can have a second pre-distorted image to be printed in a second pad printed area. In such embodiments, the overlap area between the first pad printed area and second pad printed area on the golf ball 100, 700 can be printed with non-distorted three-dimensional images created by the first and second pre-distorted two-dimensional images.

In embodiments comprising pre-distorted in a two-dimensional images, pad printing a graphic on a golf ball can comprise lifting a two-dimensionally distorted image from a first printing plate with a first pad, pad printing a first image defining a portion of the graphic on a pad printed area (e.g., a first surface area occupying at least 15% of a total surface area of the golf ball) such that the two-dimensionally distorted image is printed in a non-distorted three-dimensional form on the golf ball. After printing the first image, the golf ball can be rotated as described herein and a second two-dimensionally distorted image can be lifted from a second printing plate with a second pad and pad printed on a second pad printed area (e.g., a second surface area occupying at least 15% of the total surface area of the golf ball) such that the second two-dimensionally distorted image is printed in a non-distorted three-dimensional form on the golf ball. This process can be repeated until the desired number of images are printed on the golf ball.

In some embodiments, the pad used to print and transfer the ink from a cliché to the golf ball is a flexible or resilient material having a Shore A hardness between 20 and 70, between 30 and 60, between 35 and 55, or between 40 and 50.

System 600 can comprise a reorientation mechanism located between any two pad printing stations, or at a pad printing station, to rotate the golf ball 100 about transverse axis 194. In some embodiments, a digital encoder 630 can rotate the golf ball 100 about transverse axis 194 between two pad printing stations, or at a pad printing station. In some embodiments, additionally or alternatively, system 600 can comprise a ball rotation mechanism to rotate the golf ball 100 about longitudinal axis 192 between any two pad printing stations, or at pad printing station. In such embodiments, the ball rotation mechanism can be a mechanical mechanism with an encoder/decoder, a mechanical arm, a friction based contact member, or any other mechanical, electrical, or pneumatic device utilized to rotate the golf ball 100 about longitudinal axis 192.

In operation, system 600 can pad print a graphic 104 by pad printing a first image defining a portion of the graphic 104 with one or more pads configured to pad print on a first surface area occupying at least 20% of a total surface area of the golf ball. In embodiments comprising a first image with more than one color, two or more pads can be configured to print on the first surface area (one for the first color, another for the second color, and so on). After pad printing the first image, system 600 can rotate ball 100 about longitudinal axis 192 or transverse axis 194. And after rotating the ball 100, system 600 can pad print a second image defining a portion of the graphic 104 with one or more pads configured to pad print on a second surface area occupying at least 20% of a total surface area of the golf ball. In embodiments comprising a second image with more than one color, two or more pads can be configured to print on the second surface area (one for the first color, another for the second color, and so on).

This process for printing images and rotating the ball can repeat until the desired number of pad printed areas 110, 120, 130, 140, 150, 160 are applied to the ball. In some embodiments, ball 100 can be sequentially rotated 90° about longitudinal axis 192 to pad print two or more of pad printed areas 110, 120, 130, 140. In some embodiments, before or after printing areas 110, 120, 130, 140, system 600 can pad print one or both of areas 150, 160. Between printing areas 150 and 160, ball 100 can be rotated 180° degrees about transverse axis 194.

For example, system 600 can pad print a graphic 104 using a method comprising the following steps. First, the method comprises pad printing a first image (e.g., image 112) defining a portion of the graphic 104 with a first pad configured to pad print on a first surface area (e.g., area 110) occupying at least 20% of a total surface area of the golf ball 100, with the first image occupying a portion of the first surface area. Second, the method comprises rotating the golf ball 90° about longitudinal axis 192. Third, the method comprises pad printing a second image (e.g., image 122) defining a portion of the graphic 104 with a second pad configured to pad print on a second surface area (e.g., area 120) occupying at least 20% of the total surface area of the golf ball 100, with the second image occupying a portion of the second surface area. After printing the first and second areas, the first surface area and the second surface area partially overlap in an overlap area (e.g., area 165), and a portion of the first image is located in the overlap area and a portion of the second image is located in the overlap area.

After printing the second image, the method can comprise rotating the golf ball 90° about longitudinal axis 192 and printing a third image (e.g., image 132) defining a portion of the graphic 104 with a third pad configured to pad print on a third surface area (e.g., area 130) occupying at least 20% of the total surface area of the golf ball 100, with the third image occupying a portion of the third surface area. And after printing the third image, the method can comprise rotating the golf ball 90° about longitudinal axis 192 and printing a fourth image (e.g., image 142) defining a portion of the graphic 104 with a fourth pad configured to pad print on a fourth surface area (e.g., area 140) occupying at least 20% of the total surface area of the golf ball 100, with the fourth image occupying a portion of the fourth surface area.

In some embodiments, the method can then comprise rotating the golf ball 100 90° about transverse axis 194 and printing a fifth image (e.g., image 152) defining a portion of the graphic 104 with a fifth pad configured to pad print on a fifth surface area (e.g., area 150) occupying at least 20% of the total surface area of the golf ball 100, with the fifth image occupying a portion of the fifth surface area. And after printing the fifth image, the method can comprise rotating the golf ball 180° about transverse axis 194 and printing a sixth image (e.g., image 162) defining a portion of the graphic 104 with a sixth pad configured to pad print on a sixth surface area (e.g., area 160) occupying at least 20% of the total surface area of the golf ball 100, with the sixth image occupying a portion of the sixth surface area.

In some embodiments, graphic 104 can be printed using a solvent-based ink comprising a solvent that evaporates after one or more pad printed images is printed on surface 102. In such embodiments, the solvent-based ink used to printed areas 110, 120, 130, 140 can be dried (i.e., cured) before printing areas 150, 160, or vice versa.

In some embodiments, graphic 104 can be printed using a ultra-violet (UV) curable ink. In such embodiments, system 600 can comprise one or more UV-ink curing stations located between two pad printing stations, or at individual pad printing stations. In some embodiments, a UV-ink curing station can perform a UV pinning operation where low power level UV light is applied. In some embodiments, a UV-ink curing station can additionally or alternatively comprise a final curing station where a higher power level of UV light (when compared to the UV pinning operation) is applied to cure all the ink applied to the golf ball 100.

In some embodiments, golf ball 100 can have core and a cover layer surrounding the core. In certain embodiments, golf ball 100 can have a core, at least one mantle layer, and a cover layer. In some embodiments, the golf ball 100 can be a two-piece ball, a three-piece ball, a four-piece ball, a five-piece ball, or a six-piece ball.

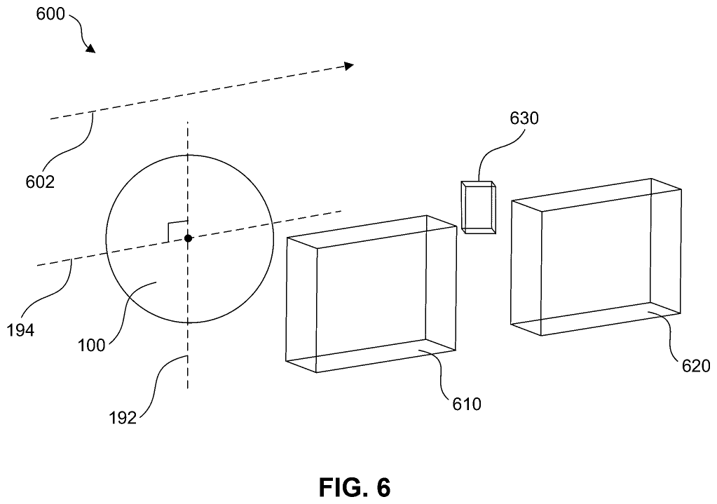

FIG. 7 illustrates another embodiment of a golf ball 700 where no portion of the ball includes an overlap of three pad printed areas. In other words, all overlap areas on the ball are created by a first pad printed area and a second pad printed area, but not a third pad printed area. As a result, a dead zone 710 can be created where no ink is applied to the ball through pad printing. In embodiments comprising one or more dead zones 710, the boundary of the dead zone(s) 710 can be defined by the perimeter edges of three pad printed areas surrounding the one or more dead zones 710. As illustrated in FIG. 7, in the dead zone(s) 710, no pad printed areas overlap each other.

FIG. 7 shows the top longitudinal axis 718 passing through the top pole, the bottom longitudinal axis 708 passing through the bottom pole, and a transverse axis 712 that is perpendicular to the longitudinal axis. A first pad printed area 706, a second pad printed area 702, and a third pad printed area 714 are shown as circular zones for case of illustration. As described herein, the pad printed areas are not limited to circular areas, but can be any shape such as an ellipse, a truncated circle, a rectangle, a triangle, a polygon, a circle with at least two substantially flat sides, or other complex non-polygonal shapes.

Only three pad printed areas are shown for ease of illustration in FIG. 7. But it is understood that a total of six pad printed areas can be placed on the ball 700 where each printed area is centered about a longitudinal axis or is centered about an axis that is perpendicular to the longitudinal axis, as shown, for example, for pad printed areas 110, 120, 130, 140, 150, 160 in FIGS. 1A and 1B. For example, the third pad printed area 714 is centered about the transverse axis 712 and the first pad printed area 706 is centered about the bottom longitudinal axis 708. The top longitudinal axis 718 and bottom longitudinal axis 708 are part of the same longitudinal axis. Each of the pad printed areas on ball 700 can comprise a pad printed image (for example, pad printed images 112, 122, 132, 142, 152, 162) as described above for pad printed areas 110, 120, 130, 140, 150, 160. Each of the pad printed images on ball 700 can comprise the same characteristics within the pad printed areas and/or overlap areas on ball 700 as described for pad printed images 112, 122, 132, 142, 152, 162 on ball 100.

FIG. 7 shows three overlap areas including a first overlap area 704, a second overlap area 720, and a third overlap area 716. However, in embodiments comprising six pad printed areas located on the ball 700, a total of twelve overlap areas will be present on the ball 700. In the simplified illustration of FIG. 7 where only three overlap areas are shown for case of illustration, the first overlap area 704 is an overlap between the first pad printed area 706 and the second pad printed area 702. The second overlap area 720 is an overlap between the first pad printed area 706 and the third pad printed area 714. The third overlap area 716 is an overlap between the second pad printed area 702 and the third pad printed area 714.

In some embodiments, the first pad printed area 706 contains at least one first color and the second pad printed area 702 contains a second color that is different from the first color. The respective colors from the first pad printed area 706 and second pad printed area 702 can be located in the first overlap area 704 so that the colors create an image in the first overlap area. In some embodiments, the colors can overlap on top of each other. In some embodiments, the colors can be interlaced to form the intended image, but not overlapped. In some embodiments, the colors can overlap on top of each other and interlaced.

In some embodiments, at least three overlap areas 704, 716, 720, or three to twelve overlap areas, can be located on the ball 700 where each overlap area contains an image or design that is created by the different color from each respective pad printed area. In some embodiments, at least two overlap areas 704, 716, or two to twelve overlap areas, can be located on the ball 700 where each overlap area contains an image or design that is created by the different color from each respective pad printed area. In some embodiments, at least four overlap areas, or four to twelve overlap areas, can be located on the ball 700 where each overlap area contains an image or design that is created by the different color from each respective pad printed area. In some embodiments, at least five overlap areas, or five to twelve overlap areas, can be located on the ball 700 where each overlap area contains an image or design that is created by the different color from each respective pad printed area. In some embodiments, at least six overlap areas, or six to twelve overlap areas, can be located on the ball 700 where each overlap area contains an image or design that is created by the different color from each respective pad printed area. In some embodiments, at least seven overlap areas, or seven to twelve overlap areas, can be located on the ball 700 where each overlap area contains an image or design that is created by the different color from each respective pad printed area. In some embodiments, at least eight overlap areas, or eight to twelve overlap areas, can be located on the ball 700 where each overlap area contains an image or design that is created by the different color from each respective pad printed area. In some embodiments, at least nine overlap areas, or nine to twelve overlap areas, can be located on the ball 700 where each overlap area contains an image or design that is created by the different color from each respective pad printed area. In some embodiments, at least ten overlap areas, or ten to twelve overlap areas, can be located on the ball 700 where each overlap area contains an image or design that is created by the different color from each respective pad printed area. In some embodiments, at least eleven overlap areas, or eleven to twelve overlap areas, can be located on the ball 700 where each overlap area contains an image or design that is created by the different color from each respective pad printed area.

Any of the embodiments described herein can have more than one color in each pad printed area. Therefore, in some embodiments, two colors in a first pad printed area (for example, the first pad printed area 706) can interact with two different colors from a second pad printed area (for example, the second pad printed area 702) to form a design or image that has four colors located in an overlap area (for example, the first overlap area 704). The image or design in each overlap area can have at least two colors, at least three colors, at least four colors, at least five colors, at least six colors, or up to one hundred colors or more. For example, in some embodiments, a first pad printed area (for example, the first pad printed area 706) can have two colors while a second pad printed area (for example, the second pad printed area 702) can have only one color, but they combine to create a three color image in an overlap area (for example, the first overlap area 704). In some embodiments, one pad printed area can have more colors than another pad printed area with which it creates an overlapping area.

In some embodiments, where at least a portion of an image or design is located in an overlap area, a golf ball having at least one to three colors in each of six printing zones where at least one color is different between two of the six printing zones is contemplated.

In some embodiments, a single overlap area can have an overlap percentage between 1% and 50% of a relative pad printed area that creates the overlap area. For example, the first pad printed area 706 can have an area of 1400 mm² and the first overlap area 704 can have an area of 14 mm², then such configuration would create an overlap area of 1%. In some embodiments, the single overlap area percentage can be between 2% and 45%, between 3% and 40%, between 4% and 35%, between 5% and 30%, between 6% and 30%, between 7% and 30%, between 8% and 30%, between 9% and 30%, between 10% and 30%, between 11% and 30%, between 12% and 30%, between 13% and 30%, between 14% and 30%, between 15% and 30%, or between 20% and 40%.

Table 2 below illustrates three embodiments having an overlap configuration similar to the overlap area configuration shown in FIG. 7, and with six pad printed areas and twelve overlap areas for full ball coverage. In a configuration with six pad printed areas, an identical pad printed area is provided on the ball that is located on the oppose side of the ball but co-axial with the three pad printed areas shown in FIG. 7. For example, the first pad printed area 706 is replicated as a fourth pad printed area centered about the top longitudinal axis 718 that is on the polar opposite side of the ball. The second pad printed area 702 is replicated as a fifth pad printed area on a polar opposite location away from the second pad printed area 702 while sharing a common centered longitudinal axis. Finally, the third pad printed area 714 is replicated as a sixth pad printed area on a polar opposite location away from the third pad printed area 714 while sharing a common centered longitudinal axis.

TABLE 2

| | Example #2 | | Example #3 | | Example #4 | |
|---|---|---|---|---|---|---|
| | | % of | | % of | | % of |
| | | Total Ball | | Total Ball | | Total Ball |
| | | Surface | | Surface | | Surface |
| | | Area | | Area | | Area |
| Ball Diameter | 42.67 | | 42.77 | | 42.82 | |
| (mm) | | | | | | |
| Total Ball | 5736.9 | 100% | 5763.3 | 100% | 5776.8 | 100% |
| Surface Area | | | | | | |
| (mm²) | | | | | | |
| Printed Planar | 34.4 | | 34.4 | | 34.4 | |
| Diameter (mm) | | | | | | |
| Printed Arc | 40 | | 40 | | 40 | |
| Diameter (mm) | | | | | | |
| First Overlap | 102.7 | 1.79% | 99.6 | 1.73% | 98.1 | 1.70% |
| Surface Area | | | | | | |
| (mm²) | | | | | | |
| Second Overlap | 102.4 | 1.78% | 99.5 | 1.73% | 98 | 1.70% |
| Surface Area | | | | | | |
| (mm²) | | | | | | |
| Third Overlap | 104.2 | 1.82% | 101.3 | 1.76% | 99.8 | 1.73% |
| Surface Area | | | | | | |
| (mm²) | | | | | | |
| First Pad | 1158.5 | 20.19% | 1156.5 | 20.07% | 1155.4 | 20.00% |
| Printed Area | | | | | | |
| including any | | | | | | |
| overlaps | | | | | | |
| (mm²) | | | | | | |
| Second Pad | 1162.4 | 20.26% | 1160.4 | 20.13% | 1159.4 | 20.07% |
| Printed Area | | | | | | |
| including any | | | | | | |
| overlaps | | | | | | |
| (mm²) | | | | | | |
| Third Pad | 1161.3 | 20.24% | 1159.5 | 20.12% | 1158.5 | 20.05% |
| Printed Area | | | | | | |
| including any | | | | | | |
| overlaps | | | | | | |
| (mm²) | | | | | | |
| Total Overlap | 1237.2 | 21.57% | 1201.7 | 20.85% | 1183.7 | 20.49% |
| Surface Area on | | | | | | |
| the Ball (12 | | | | | | |
| Overlaps) | | | | | | |
| (mm²) | | | | | | |
| Total Non | 4490.09 | 78.27% | 4549.37 | 78.94% | 4579.29 | 79.27% |
| Overlap Surface | | | | | | |
| Area Excluding | | | | | | |
| Dead Zone | | | | | | |
| (mm²) | | | | | | |
| Total Dead | 4.2 | 0.07% | 5.6 | 0.10% | 6.3 | 0.11% |
| Zone (4 Dead | | | | | | |
| Zones) | | | | | | |
| (mm²) | | | | | | |

Referring to Table 2, some embodiments can have one or more overlap areas comprising a surface area between 1% and 5%, between 1.5% and 4%, or between 1.5% and 3% of the entire outer surface area of the golf ball including dimples. For example, some embodiments can have a first overlap area between 1% and 5%, between 1.5% and 4%, or between 1.5% and 3% of the entire outer surface area of the golf ball including dimples. In some embodiments, the second overlap area can be between 1% and 5%, between 1.5% and 4%, or between 1.5% and 3% of the entire outer surface area of the golf ball including dimples. In some embodiments, the third overlap area can be between 1% and 5%, between 1.5% and 4%, or between 1.5% and 3% of the entire outer surface area of the golf ball including dimples. In some embodiments, the third overlap surface area can greater than the first and second overlap surface areas. In other embodiments, the second overlap surface area can be greater than the first and third overlap surface areas. In other embodiments, the first overlap surface area can be greater than the second and third overlap surface areas.

Some embodiments can have one or more pad printed areas occupying at least 15% of the entire outer surface area of the golf ball including dimples. Some embodiments can have one or more pad printed areas occupying at least 20% of the entire outer surface area of the golf ball including dimples. Some embodiments can have one or more pad printed areas comprising a surface area between 15% and 25% or between 20% and 25% of the entire outer surface area of the golf ball including dimples. For example, in some embodiments, the first pad printed area including any overlap areas covers between 15% to 25% or between 20% to 25% of the entire outer surface area of the golf ball including dimples. In some embodiments, the second pad printed area including any overlap areas covers between 15% and 25% or between 20% and 25% of the entire outer surface area of the golf ball including dimples. In some embodiments, the third pad printed area including any overlap areas covers between 15% and 25% or between 20% and 25% of the entire outer surface area of the golf ball including dimples. In some embodiments, two or more pad printed areas can be within 5% of each other in the terms of the entire outer surface area of the golf ball including dimples. For example, in some embodiments, the first pad printed area, second pad printed area, and third pad printed area can be within 5% of each other in the terms of the entire outer surface area of the golf ball including dimples. In other words, the pad printed areas do not have a variation of more than 5% between any two pad printed areas being compared.

In some embodiments, the total overlap surface area on the ball (defined as two pad printed areas that create the overlap-twelve total overlaps in these examples) on the entire ball in total can be between 10% and 40%, between 10% and 30%, between 18% and 22%, or between 19% and 22% of the entire outer surface area of the golf ball including dimples.

In some embodiments, the total non-overlap surface area on the ball (defined as areas covered by one pad printed area excluding dead zones-six total distinct areas in these examples) on the entire ball in total can be between 70% and 90%, between 70% and 80%, between 75% and 80%, or between 77% and 80% of the entire outer surface area of the golf ball, including dimples.

In some embodiments, the total dead zone surface area on the ball (defined as areas not covered by any pad printed area-four total distinct areas in these examples) on the entire ball in total can be between 0% and 5%, between 0% and 3%, between 0% and 2%, or between 0% and 1% of the entire outer surface area of the golf ball, including dimples. In some embodiments, the dead zone surface area can be less than 1%. The lower the dead zone value, the more surface area for potential printing is provided. In some embodiments, the surface area for one or more single dead zones can occupy less than or equal 0.5% of the entire outer surface area of the golf ball including dimples. In some embodiments, the surface area for one or more single dead zones can be between 0% and 0.5%, between 0% and 0.25%, or between 0% and 0.1% of the entire outer surface area of the golf ball including dimples. In some embodiments, the surface area for one or more single dead zones can be greater than 0% to less than or equal to 0.5%, greater than 0% to less than or equal to 0.25%, or greater than 0% to less than or equal to 0.1% of the entire outer surface area of the golf ball, including dimples.

The term “core” is intended to mean the elastic center of a golf ball. The core can be a unitary core having a center or it can have one or more “core layers” of elastic material, which are usually made of rubbery material such as diene rubbers.

The term “cover layer” is intended to mean the outermost layer of the golf ball; this is the layer that is directly in contact with paint and/or ink on the surface of the golf ball. If the cover consists of two or more layers, only the outermost layer is designated the cover layer, and the remaining layers (excluding the outermost layer) are commonly designated intermediate layers as herein defined. The term “outer cover layer” as used herein is used interchangeably with the term “cover layer.”

The term “mantle layer” may be used interchangeably herein with the terms “intermediate layer” and is intended to mean any layer(s) in a golf ball disposed between the core and the outer cover layer. Should a ball have more than one mantle layer, these may be distinguished as “inner intermediate layer ” or “inner mantle layer” which terms may be used interchangeably to refer to the intermediate layer nearest the core and furthest from the outer cover, as opposed to the “outer intermediate layer” or “outer mantle layer” which terms may also be used interchangeably to refer to the intermediate layer furthest from the core and closest to the outer cover, and if there are three intermediate layers, these may be distinguished as “inner intermediate layer” or “inner mantle layer” which terms are used interchangeably to refer to the intermediate or mantle layer nearest the core and furthest from the outer cover, as opposed to the “outer intermediate layer” or “outer mantle layer” which terms are also used interchangeably to refer to the intermediate layer further from the core and closer to the outer cover, and as opposed to the “intermediate layer” or “intermediate mantle layer” which terms are also used interchangeably to refer to the intermediate layer between the inner intermediate layer and the outer intermediate layer.

The cover layer can be used with golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from 1.680 inches to 1.800 inches. The more preferred diameter is from 1.680 inches to 1.760 inches. A diameter of from 1.680 inches to 1.740 inches is most preferred; however, diameters anywhere in the range of from 1.70 to 2.0 inches can be used. Oversize golf balls with diameters above 1.760 inches to as big as 2.75 inches are also within the scope of the present disclosure.

Each of the mantle layers of the golf balls can have a thickness of less than 0.080 inch, more particularly less than 0.065 inch, and most particularly less than 0.055 inch.

In certain embodiments, the inner mantle can have a material Shore D hardness of 15 to 65, particularly 25 to 60, and more particularly 30 to 58. The inner mantle can have a flexural modulus of 2 to 35, particularly 10 to 30, and more particularly 15 to 35, kpsi. The intermediate mantle can have a flexural modulus of 10 to 50, particularly 25 to 50, and most particularly 25 to 40, kpsi, and a material Shore D hardness of 40 to 70, more particularly from 45 to 65, and most particularly from 50 to 60. The outer mantle can have a material Shore D hardness of 55 to 75, particularly 58 to 70, and more particularly 60 to 68. The outer mantle material can have a flexural modulus of 30 to 80, particularly 40 to 80, and most particularly 50 to 75, kpsi. The core and mantle layer(s) can each include one or more of the following polymers.

Such polymers include synthetic and natural rubbers, thermoset polymers such as thermoset polyurethanes and thermoset polyureas, as well as thermoplastic polymers including thermoplastic elastomers such as unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyesters, copolyesters, polyamides, copolyamides, polycarbonates, polyolefins, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane and any and all combinations thereof. One example is PARALOID™ EXL 2691A which is a methacrylate-butadiene-styrene (MBS) impact modifier available from Rohm & Haas Co.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements.

References to “one embodiment,” “an embodiment,” “some embodiments,” “in certain embodiments,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A pad printed golf ball, comprising:
a plurality of pad printed areas, comprising:
a first pad printed area comprising a first surface area occupying at least 15% of a total surface area of the golf ball, and a first pad printed image occupying a portion of the first surface area;
a second pad printed area comprising a second surface area occupying at least 15% of the total surface area of the golf ball, and a second pad printed image occupying a portion of the second surface area;
a third pad printed area comprising a third surface area occupying at least 15% of the total surface area of the golf ball, and a third pad printed image occupying a portion of the third surface area; and
a dead zone located between the pad first printed area, the second pad printed area, and the third pad printed area,
wherein:
the first surface area and the second surface area partially overlap in a first overlap area,
the first surface area and the third surface area partially overlap in a second overlap area,
the second surface area and the third surface area partially overlap in a third overlap area, and
none of the first surface area, the second surface area, or the third surface area overlap in the dead zone.

2. The pad printed golf ball of claim 1, wherein, in the dead zone, no ink is applied to the golf ball through pad printing.

3. The pad printed golf ball of claim 1, wherein the first overlap area, the second overlap area, and the third overlap area each occupy between 1% and 5% of the total surface area of the golf ball.

4. The pad printed golf ball of claim 1, wherein the dead zone occupies less than or equal to 0.5% of the total surface area of the golf ball.

5. The pad printed golf ball of claim 1, wherein a portion of the first pad printed image is located in the first overlap area and a portion of the second pad printed image is located in the first overlap area.

6. The pad printed golf ball of claim 1, wherein the first pad printed image comprises a first color and the second pad printed image comprises a second color different from the first color.

7. The pad printed golf ball of claim 6, wherein the first color and the second color are located in the first overlap area.

8. The pad printed golf ball of claim 1, wherein, in the first overlap area, no ink defining the first pad printed image overlaps ink defining the second pad printed image.

9. The pad printed golf ball of claim 1, wherein, in the first overlap area, the first pad printed image comprises:
a first part where ink defining the first pad printed image does not overlap ink defining the second pad printed image, and
a second part wherein ink defining the first pad printed image overlaps ink defining the second pad printed image in an image overlap area,
wherein the first part of the first pad printed image comprises a first ink density, and
wherein the second part of the first pad printed image comprises a second ink density less than the first ink density.

10. The pad printed golf ball of claim 1, wherein the first pad printed area comprises a printed planar diameter between 28 mm and 37 mm.

11. The pad printed golf ball of claim 1, wherein the first pad printed area comprises a printed arc diameter between 31 mm and 45 mm.

12. The pad printed golf ball of claim 1, wherein any one of the first pad printed area, the second pad printed area, or the third pad printing area comprises a non-circular perimeter shape comprising a maximum printed arc length between 34 mm and 47 mm and a maximum printed arc width between 28 mm and 40 mm.

13. The pad printed golf ball of claim 1, wherein the first pad printed image occupies at least 20% of the first surface area, the second pad printed image occupies at least 20% of the second surface area, and the third pad printed image occupies at least 20% of the third surface area.

14. The pad printed golf ball of claim 1, wherein at least 5% of the first pad printed image is located in the first overlap area and at least 5% of the second pad printed image is located in the first overlap area.

15. A pad printed golf ball, comprising:
a plurality of pad printed areas, comprising:
a first pad printed area comprising a first surface area occupying at least 15% of a total surface area of the golf ball, and a first pad printed image occupying a portion of the first surface area;
a second pad printed area comprising a second surface area occupying at least 15% of the total surface area of the golf ball, and a second pad printed image occupying a portion of the second surface area;
a third pad printed area comprising a third surface area occupying at least 15% of the total surface area of the golf ball, and a third pad printed image occupying a portion of the third surface area;
a fourth pad printed area comprising a fourth surface area occupying at least 15% of the total surface area of the golf ball, and a fourth pad printed image occupying a portion of the fourth surface area;
a fifth pad printed area comprising a fifth surface area occupying at least 15% of the total surface area of the golf ball, and a fifth pad printed image occupying a portion of the fifth surface area;
a sixth pad printed area comprising a sixth surface area occupying at least 15% of the total surface area of the golf ball, and a sixth pad printed image occupying a portion of the sixth surface area; and
an overlap area where the first pad printed area and the second pad printed area overlap such that at least a portion of the first pad printed image and at least a portion of the second pad printed image are located in the overlap area,
wherein each of the six pad printed images comprises a color, and wherein the color for at least one of the six pad printed images is different from the color for a different one of the six pad printed images.

16. The pad printed golf ball of claim 15, wherein the first pad printed image comprises a first color located in the overlap area and the second pad printed image comprises a second color different from the first color, and wherein both the first color and the second color are located in the overlap area.

17. The pad printed golf ball of claim 15, wherein:
the overlap area is a first overlap area,
the pad printed golf ball comprises eleven additional overlap areas, and
in each of the eleven additional overlap areas, two of the respective six pad printed areas overlap such that at least a portion of the pad printed images for the two pad printed areas are located in the respective overlap area.

18. A method of pad printing a graphic on a golf ball, the method comprising:
lifting a first two-dimensionally distorted image from a first printing plate with a first pad;
pad printing a first image defining a portion of the graphic with the first pad configured to pad print on a first surface area occupying at least 15% of a total surface area of the golf ball, wherein the first image occupies a portion of the first surface area and comprises the first two-dimensionally distorted image printed in a non-distorted three-dimensional form;
rotating the golf ball about a central longitudinal axis of the ball;
lifting a second two-dimensionally distorted image from a second printing plate with a second pad; and
pad printing a second image defining a portion of the graphic with a second pad configured to pad print on a second surface area occupying at least 15% of the total surface area of the golf ball, wherein the second image occupies a portion of the second surface area and comprises the second two-dimensionally distorted image printed in a non-distorted three-dimensional form,
wherein the first surface area and the second surface area partially overlap in an overlap area, and
wherein a portion of the first image in the non-distorted three-dimensional form is located in the overlap area and a portion of the second image in the non-distorted three-dimensional form is located in the overlap area.

19. The method of claim 18, wherein the first print pad, the second print pad, or both, comprises a Shore A hardness between 30 to 60.
